(19) United States
(12) Patent Application Publication
(10) Pub. No.: US 2024/0269587 A1
(43) Pub. Date: Aug. 15, 2024

(54) CLOSURE ELEMENT FOR DRAINAGE OPENING OF FILTER SYSTEM, FILTER HOUSING PART OF FILTER SYSTEM, FILTER ELEMENT, AND FILTER SYSTEM

(71) Applicant: MANN+HUMMEL GmbH, Ludwigsburg (DE)

(72) Inventors: Jochen LINHART, Schwaikheim (DE); Frank PFLÜGER, Sachsenheim (DE)

(21) Appl. No.: 18/642,764

(22) Filed: Apr. 22, 2024

Related U.S. Application Data
(63) Continuation of application No. PCT/EP2022/080123, filed on Oct. 27, 2022.

(30) Foreign Application Priority Data
Nov. 3, 2021 (DE) 102021128603.4

(51) Int. Cl. B01D 29/96; B01D 29/13; B01D 35/30

(52) U.S. Cl. CPC B01D 29/96; B01D 29/13; B01D 35/30; B01D 2201/291; B01D 2201/347

(57) ABSTRACT

A closure element for at least one drainage opening of a filter system includes a connection segment, and a closure segment adjoining the connection segment in a longitudinal direction and comprising one or more seal regions. The connection segment and the closure segment each comprise one or more center axes extending in the longitudinal direction, and at least one of the center axes of the closure segment is arranged offset in relation to at least one of the center axes of the connection segment.

### CROSS-REFERENCE TO RELATED APPLICATIONS

This application is a continuation application of International Application No. PCT/EP2022/080123 filed on Oct. 27, 2022, which claims the benefit of German Application No. 102021128603.4 filed on Nov. 3, 2021, the entire disclosures of which are incorporated herein by reference for all purposes.

### BACKGROUND

Embodiments concern a closure element for at least one drainage opening of a filter system, a filter housing part of a filter system, a filter element, a corresponding filter system, and a use of a filter system as well as of a closure element in such a filter system.

Filter systems with exchangeable filter elements are known to a person of skill in the art. The filter systems comprise a housing in which an exchangeable filter element is arranged, wherein a filter medium of the filter element filters a fluid flow flowing through the filter element. The housing can comprise at least two housing parts which are detachably connected to each other. The housing parts form in the connected state a cavity in which the filter element is exchangeably arranged. At least one of the housing parts comprises at least one drainage opening. By releasing the at least one drainage opening, the fluid in the housing can be drained from the housing.

Closure elements which close the at least one drainage opening of the filter system in at least one first position and release it at least partially in at least one second position are also known. The closure elements can comprise at least one seal element and at least one connection element.

An exchangeable filter element comprises in general a filter medium which is designed, for example, in a hollow-cylindrical shape and is flowed through by a fluid to be purified from an outer side to an inner side and which is closed off at two oppositely positioned ends by at least two end disks. The filter medium can be supported by a central tube from the interior against the hydraulic pressure of the flowing fluid. At least one end disk can comprise at least one drainage opening. By releasing the at least one drainage opening, the fluid in the housing can be drained from the housing.

Corresponding uses of a filter system as well as of a closure element in such a filter system are also known to a person of skill in the art.

DE 102013216853 B4 discloses a filter device for filtering a fluid, in particular of a motor vehicle, with a filter housing and a filter element to be coupled thereat to a fluid-conducting connector. The fluid-conducting connector is designed with a non-rotational symmetry cross-sectional shape where the filter element, by means of a sliding movement, is to be coupled to the filter housing. At least one electrical contact between the filter housing and the filter element is provided in the filter device which can be produced also by means of the sliding movement.

EP 3666363 A1 discloses a fluid filter element. The fluid filter element comprises a filter medium which is arranged in a cylindrical arrangement around a longitudinal axis. The fluid filter element comprises furthermore a first and a second end disk which are arranged at oppositely positioned cylindrical ends of the filter medium and are sealed therewith, wherein the second end disk defines an outlet for filtered fluid. The fluid filter element comprises furthermore at least one locking projection arranged at the second end disk for rotary locking of the fluid filter at the filter support by rotating the fluid filter element about the longitudinal axis in a first rotational direction relative to the filter support. The fluid filter element comprises in addition at least one releasable holder arranged at the second end disk and correlated with the at least one locking projection in order to hold the at least one locking projection in locking engagement with the filter support and which, when it is released, enables a rotary unlocking of the fluid filter element from the filter support by rotating the fluid filter element about the longitudinal axis in a second rotational direction relative to the filter support opposite to the first rotational direction.

### SUMMARY

It is an object of the embodiments to provide a closure element for at least one drainage opening of a filter system which can be easily attached in the intended position to the filter system.

A further object of the embodiments is to provide a filter housing part of a filter system whose drainage opening can be sealed reliably by a closure element.

A further object of the embodiments is to provide a filter element whose drainage opening can be sealed reliably by a closure element.

A further object of the embodiments is to provide a filter system which can be reliably sealed by a closure element.

A further object of the embodiments is to provide a use of a filter element in a filter system which can be realized in a simple manner.

A further object of the embodiments is to provide a use of a closure element in a filter system which can be realized in a simple manner.

The aforementioned object is solved according to an aspect of the embodiments by a closure element for at least one drainage opening of a filter system, comprising a closure segment adjoining the latter in longitudinal direction, wherein at least one center axis of the closure segment is offset in relation to at least one center axis of the connection segment.

A further object is solved by a filter housing part for a filter system, comprising an interior and a drainage opening coupled to the interior, wherein the drainage opening comprises at least two sections successively arranged in longitudinal direction, wherein at least one connection section comprises a center axis extending in longitudinal direction and at least one seal section comprises a center axis extending in the longitudinal direction. The center axis of the at least one connection section is offset in relation to the center axis of the at least one seal section. The at least one connection section of the drainage opening and the connection segment of the closure element form a detachable connection and at least one of the seal regions of the closure segment of the closure element forms, together with at least one seal region of the at least one seal section of the drainage opening, a seal arrangement.

A further object is solved by a filter element with a filter medium and at least one end disk, wherein the at least one end disk comprises an engagement section with at least one center axis and at least one at least partially circumferentially extending engagement region. The at least one center axis of the engagement section is arranged offset in relation to at least one further center axis of the filter element, or offset in relation to the center axis of the end disk, or offset in relation to the further center axis of the filter element and offset in relation to the center axis of the end disk.

A further object is solved by a filter system with a filter housing part which comprises an interior and a drainage opening coupled to the interior, wherein the drainage opening comprises at least two center axes which are offset in relation to each other. A closure element with at least two center axes which are offset in relation to each other closes seal-tightly the drainage opening in at least one first position and releases the drainage opening at least partially in at least one second position. In the interior of the filter housing part, a filter element with an engagement section is arranged, wherein the engagement section is in engagement or can be brought into engagement with at least one seal region of the closure element.

A further object is solved by the use of a filter element in a filter system, wherein the filter element is inserted into an interior of the filter housing part and is aligned in relation to the filter housing part such that at least one center axis of the engagement section of the filter element is arranged offset in relation to at least one center axis of the drainage opening of the filter housing part.

A further object is solved by a use of a closure element in a filter system, wherein the closure element is inserted into the drainage opening of the filter housing part. At least a first section of a closure segment projects into the at least one seal section of the drainage opening. The at least one seal region of the closure segment and at least one seal element seal the drainage opening at the corresponding seal region of the seal section. In this context, the center axis of the first section is congruently arranged in relation to the center axis of the seal section. A connection element of the connection segment of the closure element forms together with a connection element of the connection section of the drainage opening a detachable connection, wherein the center axis of the connection segment is congruently arranged in relation to the center axis of the connection section.

Beneficial configurations and advantages of the embodiments result from the additional claims, the description, and the drawing.

According to an aspect of the embodiments, a closure element for at least one drainage opening of a filter system is proposed, comprising a connection segment and a closure segment adjoining the latter in longitudinal direction and comprising at least one seal region. The connection segment and the closure segment each comprise at least one center axis extending in longitudinal direction, wherein at least one of the center axes of the closure segment is arranged offset in relation to at least one of the center axes of the connection segment.

It is understood, of course, that the closure element according to the embodiments is not only suitable for closing drainage openings of filter systems but also for closing drainage openings of other fluid pans or fluid sumps, for example, oil pans of internal combustion engines or gearboxes. In any case, the embodiments are not explicitly limited to a use of the closure element according to the embodiments in filter systems.

A closure element is understood as a component which can be inserted into at least one drainage opening of the filter system and closes it seal-tightly in the inserted state in at least one first position. In this context, the closure element is detachably connected to the at least one drainage opening. The closure element comprises a connection segment and a closure segment.

A closure segment is understood as a segment which, in the at least one first position of the closure element, can close seal-tightly at least one of the drainage openings of the filter system. For this purpose, a seal element or seal elements can be arranged between a corresponding seal region of the closure segment and a seal region of a seal section of the drainage opening. In this context, during insertion of the closure element into the drainage opening, a seal element can be arranged at the seal region of the closure segment or at the seal region of the corresponding seal section of the drainage opening. When the seal arrangement comprises a plurality of seal elements, they can be arranged, during the insertion of the closure element into the drainage opening, at the seal region of the closure segment or at the seal region of the corresponding seal section of the drainage opening, or at least one seal element can be arranged at the seal region of the closure segment and at least one further seal element can be arranged at the seal region of the corresponding seal section of the drainage opening.

A connection segment is understood as a segment which can be detachably connected to a connection segment of the drainage opening.

The center axes of the closure element each extend centrally through the cross section of the corresponding segment or of a corresponding section of the segment. The cross sections of the segments and the cross sections of the sections of the segment can be of identical configuration and merely be arranged offset in relation to each other. In addition, the segments each can differ from each other in particular in the configuration of their cross section.

The cross sections of the segments or the cross sections of the sections can be configured with rotational symmetry in relation to the corresponding center axis or with mirror symmetry in relation to at least one plane or axis extending through the corresponding center axis. In case of non-circular cross sections, the cross sections can differ from each other due to their orientations.

Cross sections of the segments or cross sections of the sections of the segments can differ by their geometric shape, for example, an angular or a round shape. In addition, the cross sections can differ in regard to the size of the surface area or in regard to the size of the diameters or their edge lengths in case of same shapes.

For example, the closure element can be configured in a cylinder shape. In this context, the connection segment and the closure segment each can comprise a round cross section. In addition, the segments can comprise several sections with corresponding cross sections with different or same diameters. In an alternative embodiment, the closure segment or the connection segment or the closure segment and the connection element can comprise at least one angular cross section. In this way, the closure element can be adapted to various sections of the drainage openings.

The center axes each extend parallel to a longitudinal direction of the closure element. The center axes can be arranged offset in relation to each other by 0.1 mm up to 3 mm, in particular by 0.5 mm up to 1.5 mm. Due to the offset of the center axes of the closure element, at least one region is configured with an offset at an outer contour of the closure element. Further regions with an offset at the outer contour can be formed by segments or by sections of segments with different cross sections.

Due to the region or due to the regions of the outer contour with an offset, a user can easily figure out whether the closure segment or the segments of the closure element are arranged at the intended position in the drainage opening, respectively.

In addition, due to the at least one offset at the outer contour of the closure element at least one stop can be formed which determines the end position of the closure element in the drainage opening and makes difficult a too deep insertion of the closure element into the drainage opening or into the interior of the filter system coupled to the drainage opening. Due to the offset of the center axes, assembly errors such as too small or too large an insertion depth of the closure element into the drainage opening or the insertion with an orientation of the closure element that is different from the intended orientation can be avoided or at least made difficult. In addition, the arrangement of a seal element between the seal region of the closure segment and the corresponding seal region of the seal section of the drainage opening, for example, at a less exposed region of the drainage opening, can be facilitated. Due to the center axes which are offset in relation to each other, a utilization of parts of lesser quality as a replacement for the closure element can be made difficult and maintaining a quality standard can be facilitated.

According to a beneficial embodiment, the connection segment can be supported rotatably at the closure segment. Due to the rotatable support of the connection segment at the closure segment, it can be prevented that upon insertion of the connection segment into the drainage opening and/or upon fastening the connection segment to the drainage opening, radial forces are transmitted from the connection segment to the closure segment. As an alternative, due to the rotatable support of the connection segment at the closure segment, radial forces upon insertion and/or upon fastening the connection segment to the drainage opening can be attenuated. In this context, mainly axial forces in longitudinal direction can act on the closure segment. In this way, a rotation and/or twisting and/or displacement of the seal element at the closure segment can be prevented or made difficult. In this way, seal elements can shear off less frequently. In addition, the probability can be increased that, in the inserted and fastened state of the closure element in the drainage opening, the seal element is arranged at a predetermined region between the corresponding seal region of the drainage opening and the corresponding seal region of the closure segment with a predetermined shape. In this way, a sealing action of this section of the drainage opening can be reliably ensured. The closure segment can be coupled fixedly to the connection segment, whereby axial forces can be transmitted easily to the closure segment. The closure segment and the connection segment can be coupled to each other by a coupling arrangement. The coupling arrangement can comprise snap elements and/or screw elements and/or clip elements and/or locking elements and/or clamping elements. In this context, varied realizations of the coupling action between the connection segment and the closure segment are possible. This coupling can be detachable or permanent.

According to a beneficial embodiment, the closure segment can comprise at least two sections, wherein the sections each comprise a seal region and a center axis. In this context, the sections with at least one corresponding seal element can seal against different elements of the filter system or against different seal sections of the drainage opening. In this way, a reliable sealing action of different regions of the filter system with a single closure element can be achieved. A plurality of sections of the closure segment can have different cross sections. In this way, the seal regions of different sections are arranged displaced inwardly or outwardly at the outer contour of the closure segment. In addition, a plurality of sections of the closure segment can comprise a common center axis, whereby the corresponding seal regions can be arranged coaxially in relation to each other about the common center axis. In an alternative configuration, the center axes of the sections of the closure segments can be arranged offset in relation to each other. The seal regions each extend about the corresponding center axis. In this context, the seal regions of various sections can also be arranged inwardly or outwardly displaced at the outer contour of the closure element. In this configuration, the cross sections of the sections can be embodied to be identical or different. In this context, a plurality of seal regions can be arranged at a fixed angle at the closure segment. The seal regions of the closure segment can comprise at least one seal receptacle for the seat element or at least one contact surface for the seal element. A seal receptacle can correspond to a seal groove in which a seal element is inserted. The seal regions and corresponding seal elements can be arranged in particular so as to extend continuously circumferentially at the closure segment. In this context, a plurality of seal regions can be arranged spaced apart from each other in longitudinal direction. In an alternative embodiment, a plurality of seal regions can be arranged with rotational symmetry in relation to the corresponding center axis. Optionally or additionally, a plurality of seal regions can be arranged mirror symmetrically to an axis extending in the plane of the corresponding cross section and through the corresponding center axis.

According to a beneficial embodiment, the connection segment can comprise at least one connection element which is configured complementary to a connection element of the drainage opening. For example, the connection element can correspond to an outer thread or an element of a bayonet connection or an element of a locking connection or an element of a clamping connection or an element of a clip connection or an element of a snap connection. Due to the connection elements at the connection segment and at the drainage opening, the connection segment can be connected detachably to the drainage opening in a simple manner.

According to a beneficial embodiment, the connection segment can comprise at an end region at least one actuation element for introducing an actuation moment. The end region of the connection segment which comprises the actuation element can be an end region facing away from the closure segment. The at least one actuation element can comprise, for example, an engagement contour in form of a hexagon socket, hexagon head, slotted profile, cross-slotted profile or triple square socket.

In this context, the engagement contour can be raised in relation to a surface of the end region or recessed in the surface. The engagement contour can be in conformity with known contours, for example, with a triple square contour, or the engagement contour can be adapted to its own tool. Optionally, the actuation element can be a lever which is connected to the end region. By means of the actuation element, forces can be transmitted easily from the user to the closure element so that connecting the connection segment to the connection section of the drainage opening and detaching the connection segment from the connection section of the drainage opening can be facilitated. Depending on the configuration of the actuation element, suitable tools can be used. In addition, the tools can be adapted to the filter system or to the installation space in which the filter system is arranged and, in this way, can also be used for introducing the forces when the actuation element is accessible from the exterior only with difficulty.

According to a beneficial embodiment, the connection segment can comprise a larger cross section than the closure segment. In this context, the connection segment can project at least partially past the closure segment. In this way, it can be easily predetermined which segment is to be introduced first into the drainage opening, whereby mounting of the closure element in the drainage opening can be further facilitated. In this context, the closure element can be inserted into a drainage opening which comprises a connection section and at least one seal section. The seal section is correlated with an end region of the drainage opening which is facing the interior of the filter system; the connection section is correlated with an end region of the drainage opening which is facing away from the interior of the filter system. The larger cross section of the closure segment can cover the inwardly positioned seal section, whereby the at least one seal element, which is arranged between the seal region of the drainage opening in the seal section and the seal region of the closure segment, can be protected from outer influences. For example, the at least one seal element can be protected from dirt or other outer influences.

According to a further aspect of the embodiments, a filter housing part for a filter system comprising an interior and a drainage opening coupled to the interior is proposed, wherein a closure element seal-tightly closes the drainage opening in at least one first position and releases at least partially the drainage opening in at least one second position. The drainage opening comprises at least two sections arranged successively in longitudinal direction, wherein at least one connection section comprises a center axis extending in longitudinal direction and wherein at least one seal section comprises a center axis extending in longitudinal direction and at least one seal region. The center axis of the at least one connection section is arranged offset in relation to the center axis of the at least one seal section, wherein the at least one connection section of the drainage opening and a connection segment of the closure element form a detachable connection and at least one of the seal regions of a closure segment of the closure element together with the seal region of the at least one seal section of the drainage opening with a seal element form a seal arrangement.

In the at least one first position of the closure element, the center axis of the connection segment of the closure element is arranged congruently in relation to the center axis of the corresponding connection section of the drainage opening. At least one of the center axes of the closure segment of the closure element, which is arranged offset in relation to at least one of the center axes of the connection segment, is arranged congruently in relation to the center axis of the corresponding seal section of the drainage opening. In this context, the drainage opening and the closure element have the same axis offset. Due to the offset axes of the closure element and of the drainage opening, the orientation of the closure element in the drainage opening is predetermined. In addition, the drainage opening comprises at the inner wall, due to the center axes of the sections being offset in relation to each other, projections and/or recesses which are configured complementarily to projections and/or recesses of the outer contour of the closure element. In this way, stops for the closure element in the drainage opening are formed which predetermine an end position for insertion. In addition, a user can better determine due to the projections and/or recesses whether the segments of the closure element are arranged in the predetermined sections of the drainage opening. Due to the reliable arrangement of the closure segment in a predetermined position, a reliable sealing action of the drainage opening can be realized.

The seal element can be embodied as a seal ring and can be arranged between the corresponding seal regions of the closure segment and of the seal section of the drainage opening. In this context, the at least one seal section of the drainage opening can comprise a seal region which is embodied as a seal receptacle or as a seal surface. The closure segment can comprise a seal region which is embodied as a seal receptacle or as seal surface. In the at least one first position of the closure element, the at least one seal region of the closure segment is arranged opposite to the at least one seal region of the corresponding seal section of the drainage opening.

In case of a cylinder-shaped embodiment of the filter housing part, the drainage opening can be arranged off-center eccentrically at the filter housing part. In addition, the drainage opening can be arranged at a downwardly positioned side of the filter housing part in the direction of gravity. In this way, the center axes of the drainage opening can be arranged offset in relation to a center axis of the filter housing part.

The filter housing part can be configured as a filter pot for a liquid filter, in particular a fuel filter or oil filter.

According to a beneficial embodiment, the at least one connection section can be arranged at a region of the drainage opening facing away from the interior of the filter housing part and the at least one seal section at a region of the drainage opening facing the interior of the filter housing part. In this way, a first section of the closure segment can be arranged at the seal section and at least one further section of the closure segment can project into the interior of the filter housing part. In addition, it can be prevented by this arrangement that the connection elements of the connection segment and of the connection section and/or the coupling elements of the closure element can come into contact with the fluid in the sealed state of the drainage opening.

According to a beneficial configuration, the at least one connection section of the drainage opening can comprise a larger cross section than the at least one seal section of the drainage opening. In this way, the drainage opening can taper from the exterior to the interior and predetermine an insertion direction as well as an orientation of the closure element for insertion. In addition, the connection segment can correspondingly project at least partially past the closure segment. In this way, it can be simply predetermined which segment is to be inserted first into the drainage opening, whereby mounting of the closure element in the drainage opening can be further facilitated. The seal section is correlated with an end region of the drainage opening which is facing the interior of the filter system; the connection section is correlated with an end region of the drainage opening facing away from the interior of the filter system. The larger cross section of the closure segment can cover the inwardly positioned seal section, whereby the at least one seal element which is arranged between the seal region of the drainage opening in the seal section and the seal region of the closure segment can be protected from outer influences. For example, the at least one seal element can be protected from dirt or other outer influences.

According to a beneficial embodiment, the at least one connection section of the drainage opening and the connection segment of the closure element each can comprise detachable connection elements which are complementary to each other. For example, the connection segment of the closure element can comprise an outer thread and the connection section of the drainage opening an inner thread. Optionally or in addition, the connection segment can comprise at least one spring-supported element which engages a corresponding receptacle of the connection section of the drainage opening. Optionally or in addition, the connection section of the drainage opening can comprise the at least one spring-supported element which engages a corresponding receptacle of the connection segment. Optionally or in addition, a projection can be arranged at the connection segment which is inserted into a bent or curved guide recess of the connection section. As an alternative or in addition, the projection can also be arranged at the connection section and the guide recess at the connection segment. A plurality of connection arrangements is conceivable and realizable. Due to a rotatable support of the connection segment at the closure segment, the rotational movement of the connection segment substantially cannot be transmitted to the closure segment upon connecting to the connection section. In this way, mechanical influences on the at least one seal element can be reduced.

According to a beneficial embodiment, walls of the drainage opening can comprise a profile arranged outside of the at least one seal region. In this way, it can be prevented that seal elements are arranged at regions other than the predetermined seal regions. In this way, it can be achieved that seal elements are arranged at protected regions, whereby the service life of the seal elements can be extended and/or the reliability of the seal elements can be improved.

According to a further aspect of the embodiments, a filter element with a filter medium and at least one end disk is proposed, wherein the at least one end disk comprises an engagement section with at least one center axis extending in longitudinal direction and at least one engagement region. At least one of the center axes of the engagement section is offset in relation to at least one further center axis of the filter element and/or offset in relation to the center axis of the end disk. The filter element can comprise a plurality of center axes. In this context, a jacket which can surround the filter element at least partially can extend about at least one center axis and each end disk comprises a center axis. In addition, the filter medium can comprise a center axis. An inlet can also comprise a center axis extending in longitudinal direction in case of a corresponding orientation.

The jacket can be arranged centrally or off-center at the end disk. In this context, the center axis of the jacket can be arranged congruently in relation to the center axis of the end disk or congruently in relation to the center axis of the outlet opening. An offset arrangement of the center axis of the jacket in relation to the center axis of the end disk or in relation to the center axis of the drainage opening or in relation to the center axis of the end disk and in relation to the center axis of the drainage opening is also conceivable. A plurality of end disks can comprise congruent center axes or center axes which are offset in relation to each other.

The filter element can be arranged centrally or off-center in the filter housing part. A further section of the closure segment of the closure element projecting into the interior of the filter housing part can project into the drainage opening of the filter element and close it seal-tightly.

The end disk of the filter element or another part of the filter element, for example, the central tube or an outer jacket, can comprise guide elements and fastening elements. The filter element can be guided due to the guide elements by corresponding guide elements of the filter housing part so that the filter element is arranged in a predetermined end position and, depending on the guiding action, in a certain orientation in the filter housing part. Due to the fastening elements, the filter element can be fixed in this position at the filter housing part, whereby an accidental displacement of the filter element in the filter housing part in operation or during transport or during insertion of the closure element can be avoided.

According to an exemplary further embodiment of the filter element, the engagement section can be a drainage opening which passes through the end disk and is in fluid communication with an element interior, and wherein the engagement region is a seal region.

In other embodiments, the engagement section can however also be a purely mechanical engagement element that does not pass through the end disk and therefore does not enable a drainage function. For example, the engagement element can be provided as a socket section or sleeve section on the end disk. The socket section or sleeve section can comprise a wall which extends in circumferential direction and which is continuous or non-continuous. In an operating state of the filter element in a filter system, in particular a second section of the closure segment of the closure element can be brought into engagement with the engagement section and/or the drainage opening. Either the engagement at the second section of the closure segment of the closure element serves only to provide a purely mechanical connection or a sealing action for controlling a fluid drainage process can be achieved in this way.

According to a further aspect of the embodiments, a filter system with a filter housing part is proposed which comprises an interior and a drainage opening which is coupled to the interior, wherein a closure element closes seal-tightly the drainage opening in at least one first position and releases the drainage opening in at least one second position at least partially, wherein a filter element with an engagement section is arranged in the interior of the filter housing part, wherein the engagement section of the filter element is in engagement or can be brought into engagement with at least one seal region of the closure element.

In a preferred embodiment, the engagement section of the filter element can be a drainage opening, wherein the drainage opening of the filter element is coupled fluidically with the drainage opening of the filter housing part, preferably by an end region of the drainage opening of the filter element which is facing the filter housing part.

The drainage opening of the filter housing part can comprise at least two sections which are arranged successively in longitudinal direction, wherein at least one connection section comprises a center axis extending in longitudinal direction and wherein at least one seal section comprises a center axis extending in longitudinal direction and at least one seal region. The center axis of the at least one connection section is arranged offset in relation to the center axis of the at least one seal section, wherein the at least one connection section of the drainage opening and the connection segment of the closure element form a detachable connection and at least one of the seal regions of the closure segment of the closure element together with the seal region of the at least one seal section of the drainage opening with at least one seal element form a seal arrangement.

In the at least one first position of the closure element, the center axis of the connection segment of the closure element is arranged congruently in relation to the center axis of the corresponding connection section of the drainage opening. At least one of the center axes of the closure segment of the closure element, which is arranged offset in relation to at least one of the center axes of the connection segment, is arranged congruently in relation to the center axis of the corresponding seal section of the drainage opening. Due to the offset axes of the closure element and of the drainage opening, the orientation of the closure element in the drainage opening is predetermined. In addition, due to the center axes of the sections which are offset in relation to each other, the drainage opening at the inner wall comprises projections and/or recesses which are complementary to projections and/or recesses of the outer contour of the closure element. In this way, stops for the closure element in the drainage opening are formed which predetermine an end position for insertion. In addition, due to the projections and/or recesses, a user can better estimate whether the segments of the closure elements are arranged in the intended sections of the drainage opening. Due to the reliable arrangement of the closure segment in a predetermined position, a reliable sealing action of the drainage opening can be realized.

A seal element can be embodied as a seal ring and arranged between the seal region of the closure segment and the corresponding seal region of the seal section of the drainage opening. In this context, the at least one seal section of the drainage opening can comprise a seal region which is embodied as a seal receptacle or as a seal surface. The closure segment can comprise a seal region which is embodied as a seal receptacle or as a seal surface. In the at least one first position of the closure element, the at least one seal region of the closure segment is arranged oppositely positioned to the at least one seal region of the corresponding seal section of the drainage opening.

In case of a cylinder-shaped embodiment of the filter housing part, the drainage opening can be arranged off-center eccentrically at the filter housing part. In addition, the drainage opening can be arranged at a downwardly positioned side of the filter housing part in the direction of gravity. In this way, the center axes of the drainage opening can be arranged offset in relation to a center axis of the filter housing part.

The filter element can be arranged centrally or off-center in the filter housing part. One of the further sections of the closure segment of the closure element projecting into the interior of the filter housing part can project into the drainage opening of the filter element and close it off seal-tightly.

According to a beneficial embodiment, a center axis of the drainage opening of the filter element can be arranged offset in relation to the center axis of the filter element and/or offset in relation to a center axis of the filter housing part and/or offset in relation to at least one center axis of the drainage opening of the filter housing part. Since the drainage opening of the filter element is arranged offset in relation to at least one other center axis of the filter element or of the filter housing part, the number of possible orientations of the filter element in the filter housing part can be reduced. In this way, an orientation or arrangement of the filter element in the filter housing part can be predetermined so that errors upon installation in the filter housing part can be reduced. In addition, it can be prevented that filter elements without at least one center axis offset in relation to other center axes can be arranged in the filter housing part. In this way, a quality standard can be ensured.

Furthermore, the center axis of the drainage opening and the center axis of a second section of the closure element, which projects in the inserted state of the closure element into the drainage opening of the filter element, can be congruent. In this context, the center axis of the second section of the closure segment can be arranged offset in relation to at least one center axis of the closure element. Due to the offset axes of the closure element and of the drainage opening of the filter element, the orientation of the closure element can be predetermined. In addition, the closure element comprises furthermore projections and recesses which are complementary to projections and/or recesses at the transition between the drainage opening of the filter housing part and the drainage opening of the filter element. In this way, stops for the closure element are formed which predetermine an end position for insertion. In addition, due to the projections and/or recesses, a user can better estimate whether the segments and sections of the closure element are arranged in the predetermined sections of the drainage opening and in the drainage opening of the filter element. Due to the reliable arrangement of the closure segment in a predetermined position, a reliable sealing action of the drainage openings can be realized. In addition, the closure segment of the closure element can be adapted to the transition between the drainage opening of the filter housing part and the drainage opening of the filter element.

According to a beneficial configuration, a cross section of the drainage opening of the filter element can be smaller than at least one cross section of the drainage opening of the filter housing part. In this way, an end region of the drainage opening of the filter element which is facing an end region of the drainage opening of the filter housing part facing the interior can be arranged above the drainage opening of the filter housing part so that a fluid which is flowing out of the drainage opening of the filter element flows into the drainage opening of the filter housing part. Due to the smaller cross section, the drainage opening of the filter element can act as a funnel.

According to a beneficial embodiment, in the at least one first position of the closure element, at least one section of the closure segment of the closure element projecting into the interior of the filter housing part can seal the drainage opening of the filter element with the corresponding seal region. In this way, two drainage openings can be closed and sealed by one closure element at the same time. In a further position, the closure element can at least partially release the drainage opening of the filter element and still close seal-tightly the drainage opening of the filter housing part. Optionally, the closure element can close the drainage opening of the filter element in a further position and release at least partially the drainage opening of the filter housing part.

According to a beneficial embodiment, the filter element can be fastened detachably by a fastening arrangement at the filter housing part, wherein the fastening arrangement comprises filter element-associated fastening elements and housing part-associated fastening elements interacting therewith. The distribution of the fastening elements at the filter element can be limited only by the position of the fastening elements at the filter housing part with which they form a connection. In this context, pairs of filter element-associated fastening elements and housing part-associated fastening elements can be formed. How the pairs are arranged relative to each other can be freely selected depending on installation space or as a function of other factors. Due to the fastening arrangement, the filter element can be held safely in the filter housing part so that, in operation or during transport or during insertion of the closure element, a displacement of the filter element is made more difficult so that the reliability of the filter system can be improved.

According to a beneficial configuration, a housing wall of the filter housing part can comprise guide elements guiding guide elements of the filter element. By guiding the filter element into an end position, fastening elements arranged at the filter element and fastening elements arranged at the filter housing part can be joined with each other. The drainage opening of the filter element can be coupled fluidically in the end position of the filter element to the drainage opening of the filter housing part. In this context, the guide elements can be configured such that the filter element can be inserted only with a defined orientation into the filter housing part. For example, a guide element at the filter housing part and a guide element at the filter element can be designed wider than other guide elements.

According to a further aspect of the embodiments, a use of a filter element in a filter system is proposed, wherein the filter element is inserted into an interior of a filter housing part and is oriented in relation to the filter housing part in such a way that at least one center axis of an engagement section of the filter element is arranged offset in relation to at least one center axis of a drainage opening of the filter housing part. When the engagement section of the filter element is a drainage opening, the drainage openings can be fluidically coupled to each other. In this context, a closure element with at least two center axes can close seal-tightly both drainage openings in at least one first position.

According to a beneficial embodiment, the filter element can be oriented in relation to the filter housing part such that filter element-associated fastening elements and housing part-associated fastening elements form a detachable fastening of the filter element at the filter housing part. Due to the fastening arrangement formed by filter element-associated fastening elements and housing part-associated fastening elements, the filter element can be reliably fixed in the filter housing part.

According to a further aspect of the embodiments, a use of a closure element in a filter system is described, wherein the closure element is inserted into a drainage opening of a filter housing part. At least one further section of a closure segment projects into at least one seal section of the drainage opening. At least one seal region of the closure segment, at least one seal region of the seal section of the drainage opening, and at least one seal element can seal the drainage opening in the corresponding seal section. A center axis of a first section is arranged congruently in relation to a center axis of the seal section. A connection element of a connection segment of the closure element forms together with a connection element of a connection section of the drainage opening a detachable connection, wherein a center axis of the connection segment is arranged congruently in relation to a center axis of the connection section. Due to the offset center axes of the drainage opening and of the closure element, a user can easily align the closure element and transfer it into the predetermined first position. In addition, the stops at the closure element and at the drainage opening can provide a haptic feedback in regard to reaching a first end position.

According to a beneficial embodiment, at least one second section of the closure segment can project into an engagement section of a filter element. In this context, a center axis of the second section of the closure segment is arranged congruently in relation to a center axis of the engagement section of the filter element.

In a preferred further embodiment of the use of the closure element, it is possible that at least one second section of the closure segment projects into a drainage opening of a filter element. In this context, a corresponding seal region of the drainage opening of the filter element, the at least one seal region of the second section of the closure segment, and at least one seal element seal the drainage opening. In this context, a center axis of the second section of the closure segment is arranged congruently in relation to a center axis of the drainage opening.

Due to such a configuration of the closure segment, filter element and filter system can be advantageously sealed. The filter element can be fixed reliably in the filter housing part of the filter system.

Since the subject matter of closure element for at least one drainage opening of a filter system, filter housing part of a filter system, filter element, filter system, use of a filter element, and use of a closure element in a filter system constitute a single inventive concept, all features disclosed in regard to one or a plurality of the subject matter can also be combined individually or in groups with other subject matter according to the embodiments.

### BRIEF DESCRIPTION OF DRAWINGS

Further advantages result from the following drawing description. In the drawings, the embodiments are illustrated. The drawings, the description, and the claims contain numerous features in combination. A person of skill in the art will consider the features expediently also individually and combine them to expedient further combinations.

FIG. 1 shows a side view of the closure element according to embodiments.

FIG. 2 shows a section illustration of the closure element according to FIG. 1.

FIG. 3 shows a perspective view of the closure element according to FIGS. 1 and 2.

FIG. 4 shows a section illustration of the lower region of a filter system with a closure element according to FIGS. 1 to 3.

FIG. 5 shows a side view of a closure element according to embodiments.

FIG. 6 shows a section illustration of the closure element according to FIG. 5.

FIG. 7 shows a perspective view of the closure element according to FIGS. 5 and 6.

FIG. 8 shows a section illustration of a lower region of a filter system with a closure element according to FIGS. 5 to 7.

FIG. 9 shows a side view of a closure element according to embodiments.

FIG. 10 shows a section illustration of the closure element according to FIG. 9.

FIG. 11 shows a perspective view of the closure element according to FIGS. 9 and 10.

FIG. 12 shows a section illustration of a lower region of a filter system with a closure element according to FIGS. 9 to 11.

FIG. 13 shows a side view of a connection segment of a closure element according to embodiments.

FIG. 14 shows a section illustration of a lower region of a filter system with a closure element according to FIG. 13.

FIG. 15 shows a side view of a connection segment of a closure element according to embodiments.

FIG. 16 shows a section illustration of a lower region of a filter system with a closure element according to FIG. 15.

FIG. 17 shows a section illustration of a lower region of a filter system with a closure element according to embodiments.

FIG. 18 shows a further section illustration of the filter system according to FIG. 17 along the section line XVIII.

FIG. 19 shows a section illustration of a lower region of a filter system with a closure element according to embodiments.

FIG. 20 shows a section illustration of a lower region of a filter system with a closure element according to embodiments.

FIG. 21 shows a side view of a filter housing part according to embodiments.

FIG. 22 shows a section illustration of a filter system with a filter housing part according to FIG. 21 along the section line XXII.

FIG. 23 shows a perspective section illustration of a filter housing part according to embodiments.

FIG. 24 shows a perspective view of a part of a filter element according to embodiments.

FIG. 25 shows a perspective section illustration of a filter system with a filter housing part according to FIG. 23 and a part of a filter element according to FIG. 24 in an intermediate position and a closure element according to FIG. 17.

FIG. 26 shows a perspective section illustration of a filter system with a filter housing part according to FIG. 23 and a part of a filter element according to FIG. 24 in an end position and a closure element according to FIG. 17.

FIG. 27 shows a perspective section illustration of a filter system with a filter housing part according to embodiments and a part of a filter element according to embodiments in an intermediate position and a closure element according to FIG. 17.

FIG. 28 shows a perspective section illustration of a filter system with a filter housing part according to embodiments and a part of a filter element according to embodiments in an intermediate position and a closure element according to FIG. 17.

FIG. 29 shows a perspective section illustration of a filter system with a filter housing part according to embodiments and a part of a filter element according to embodiments in an intermediate position and a closure element according to FIG. 17.

### DETAILED DESCRIPTION

In the Figures, same or same-type components are identified with same reference characters. The Figures show only examples and are not to be understood as limiting.

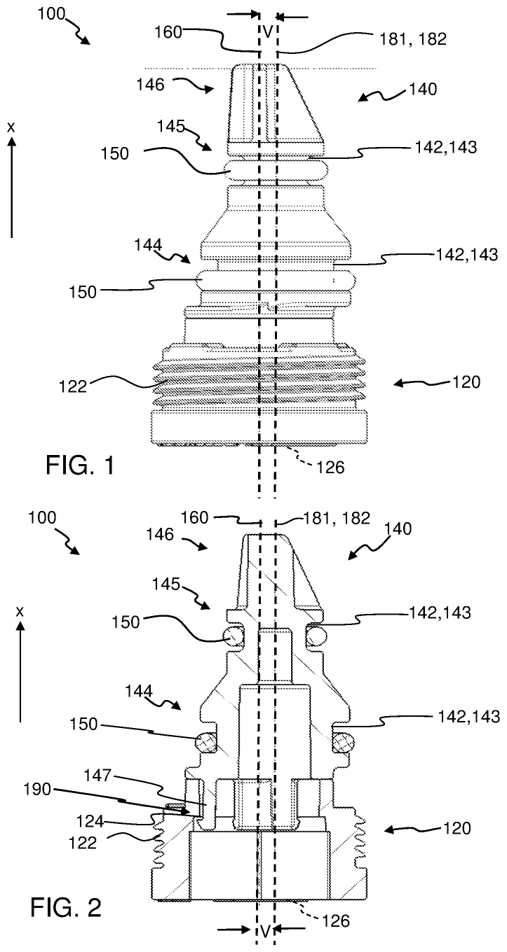

For explaining the embodiments, FIGS. 1 to 3 show different illustrations of a first embodiment of a closure element 100. FIG. 4 shows a section illustration of a lower region of a filter system 10 with such a closure element 100, a filter housing part 200, and a filter element 300.

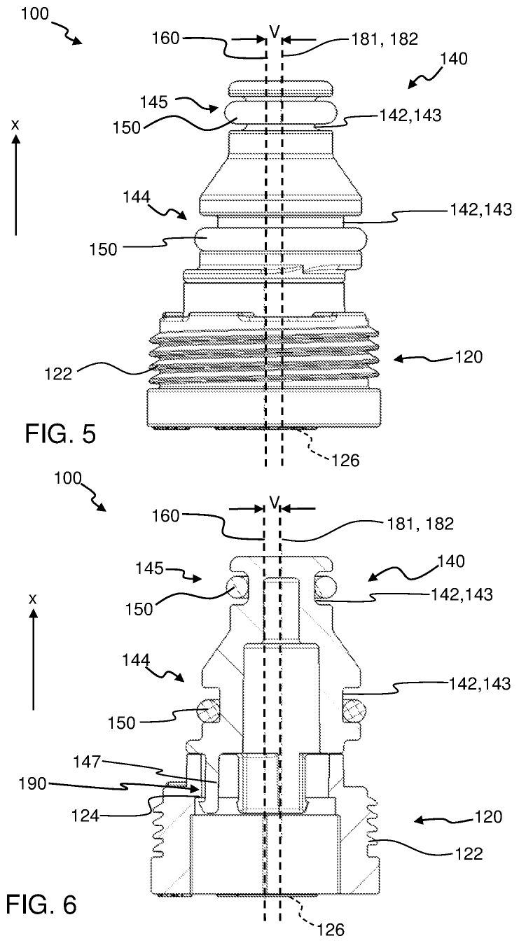

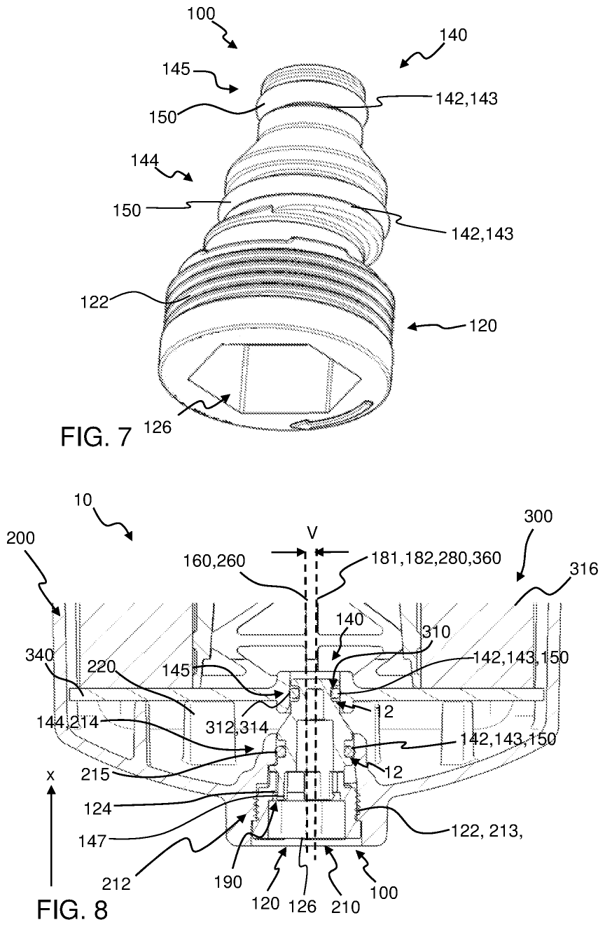

FIGS. 5 to 7 show various illustrations of a second embodiment of a closure element 100. FIG. 8 shows a section illustration of a lower region of a filter system 10 with such a closure element 100, a filter housing part 200, and a filter element 300.

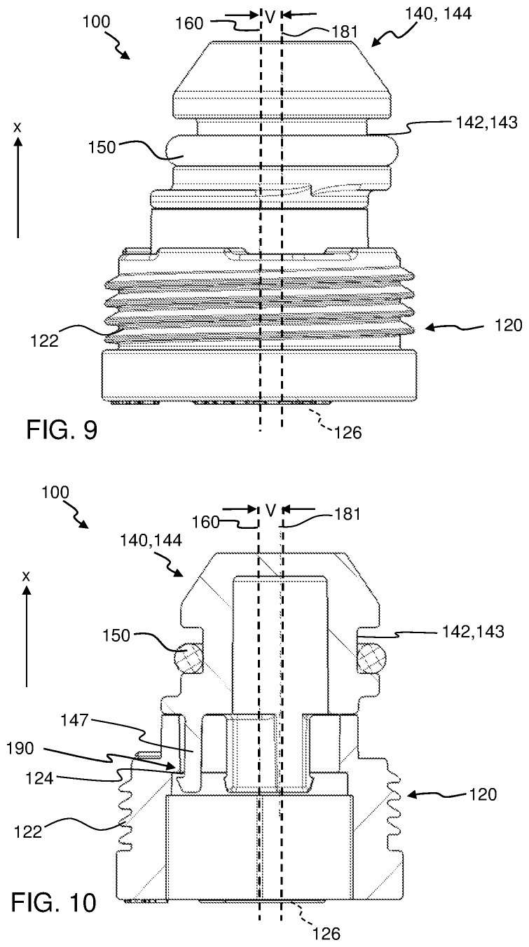

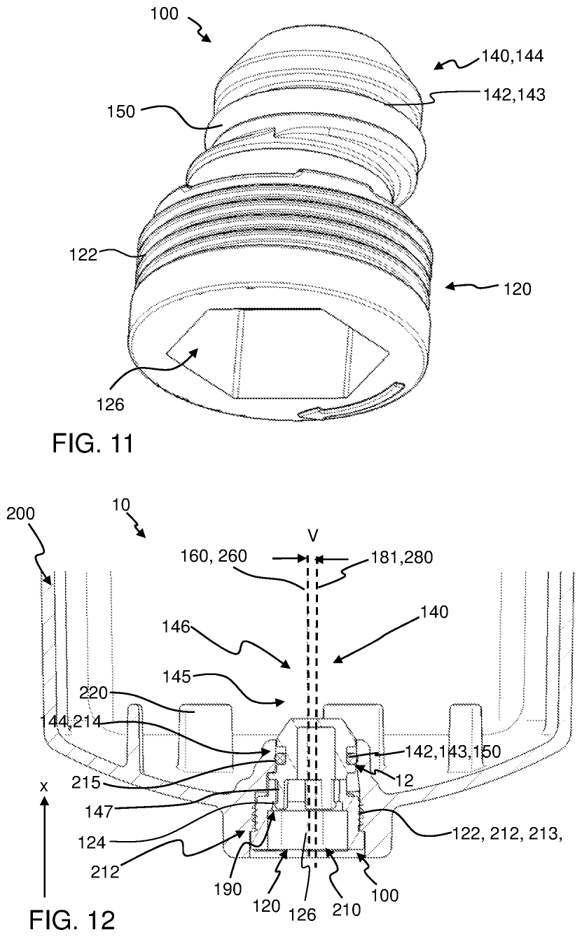

FIGS. 9 to 11 show various illustrations of a third embodiment of a closure element 100. FIG. 12 shows a section illustration of a lower region of a filter system 10 with such a closure element 100 and a filter housing part 200.

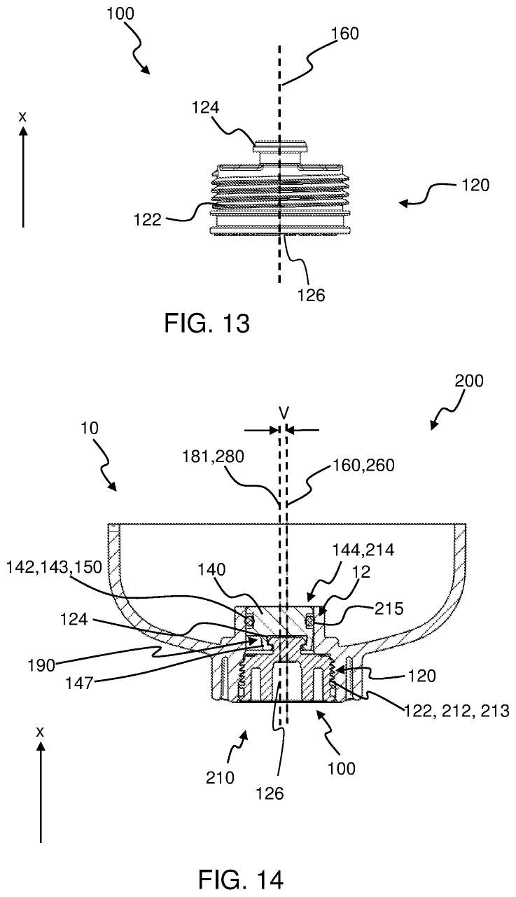

FIG. 13 shows a side view of a connection segment 120 of a fourth embodiment of a closure element 100. FIG. 14 shows a section illustration of a lower region of a filter system 10 with such a closure element 100 and a filter housing part 200.

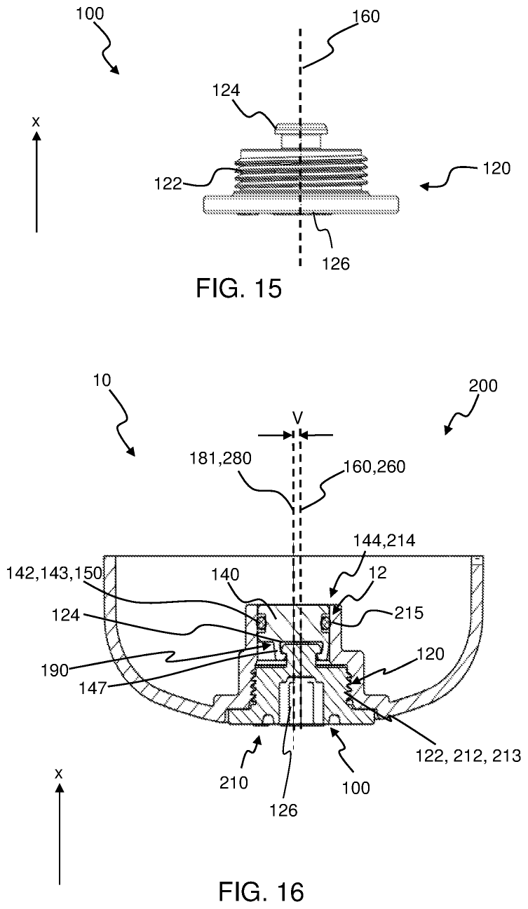

FIG. 15 shows a side view of a connection segment 120 of a fifth embodiment of a closure element 100. FIG. 16 shows a section illustration of a lower region of a filter system 10 with such a closure element 100 and a filter housing part 200.

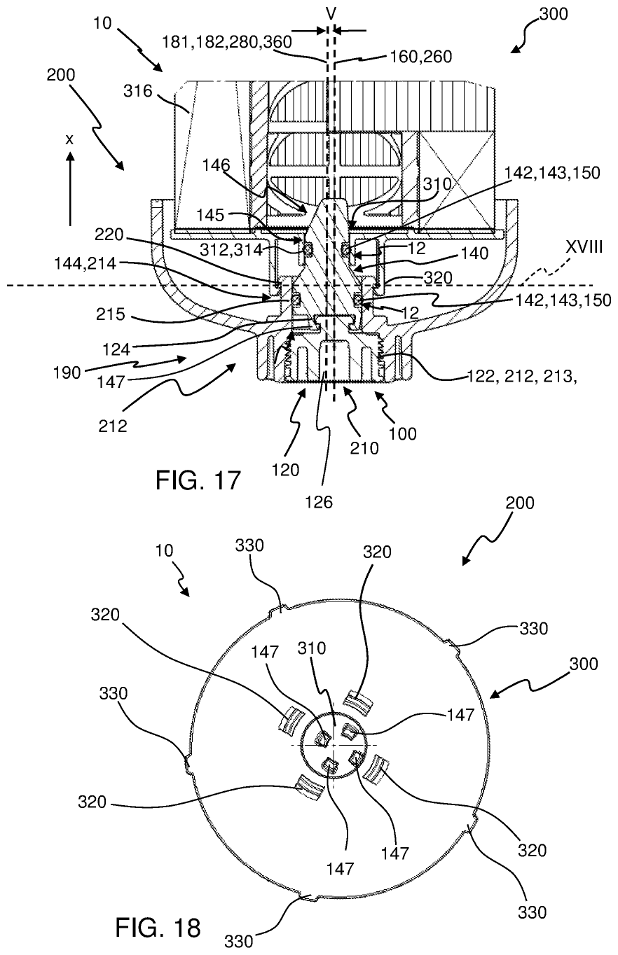

FIG. 17 shows a section illustration of a lower region of an embodiment of a filter system 10 with a sixth embodiment of a closure element 100, a filter housing part 200, and a filter element 300. FIG. 18 shows a further section illustration of this filter system 10 along the section line XVIII.

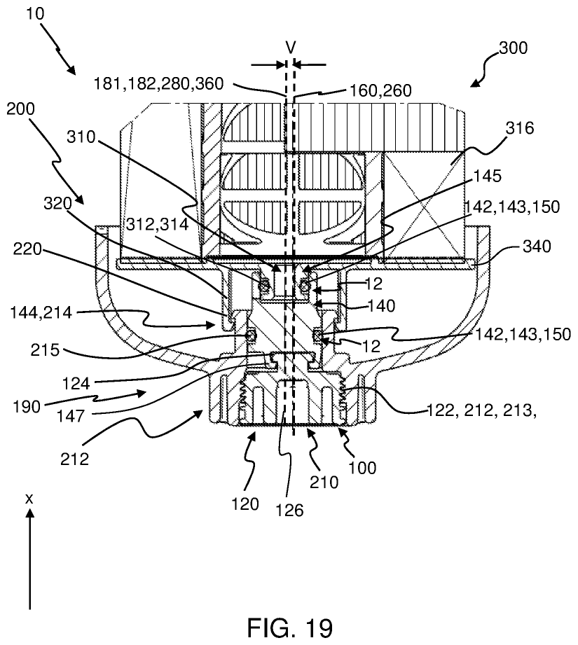

FIG. 19 shows a section illustration of a lower region of an embodiment of a filter system 10 with a seventh embodiment of a closure element 100, a filter housing part 200, and a filter element 300.

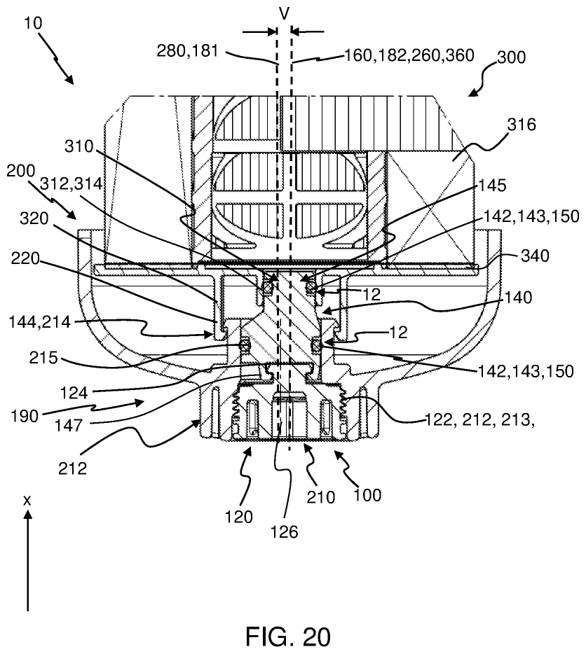

FIG. 20 shows a section illustration of a lower region of an embodiment of a filter system 10 with an eighth embodiment of a closure element 100, a filter housing part 200, and a filter element 300.

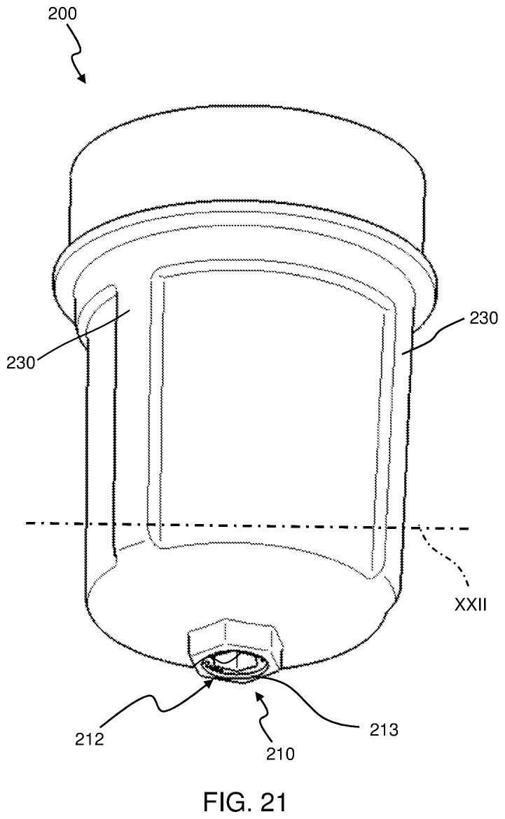

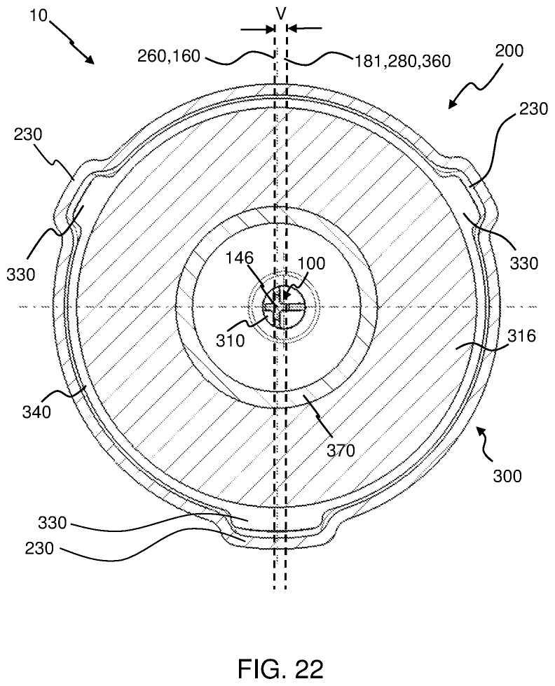

FIG. 21 shows a perspective view of an embodiment of the filter housing part 200 and FIG. 22 shows a section illustration of a filter system 10 with such a filter housing part 200 and a filter element 300 along the section line XXII.

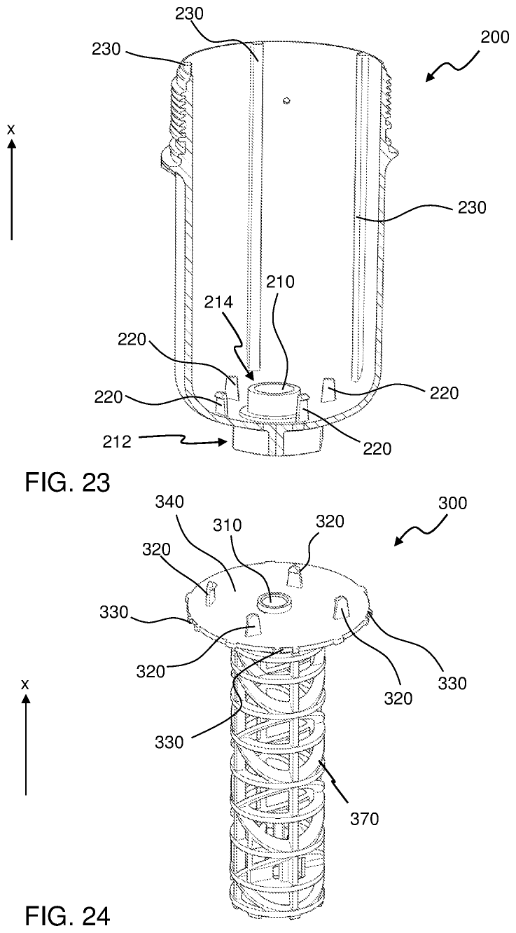

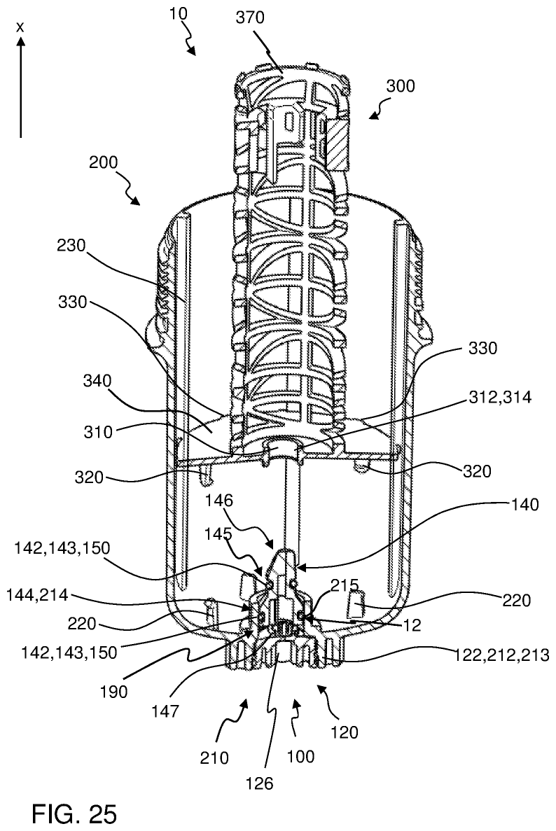

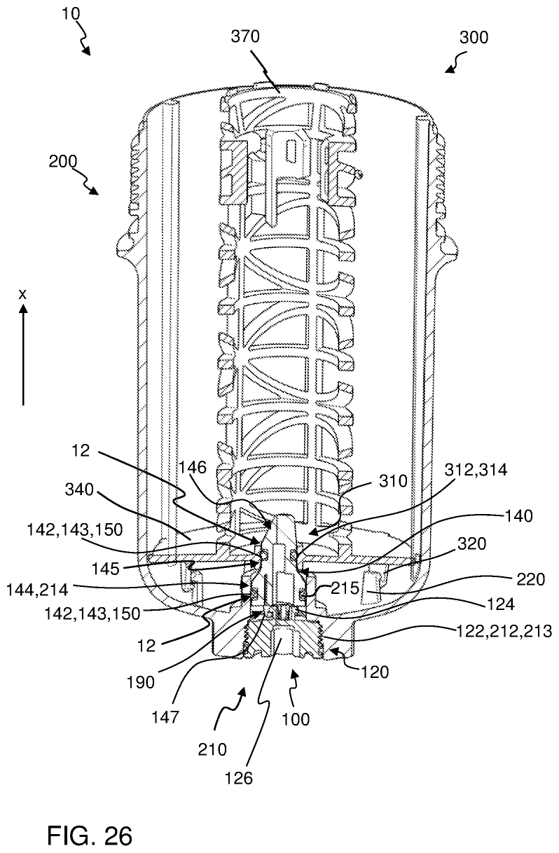

FIG. 23 shows a perspective section illustration of a further embodiment of a filter housing part 200. FIG. 24 shows a perspective view of a part of a filter element 300. FIG. 25 shows a perspective section illustration of an embodiment of a filter system 10 with such a filter housing part, such a filter element 300 in an intermediate position, and the sixth embodiment of the closure element 100. FIG. 26 shows the filter system 10 with a filter element 300 in an end position.

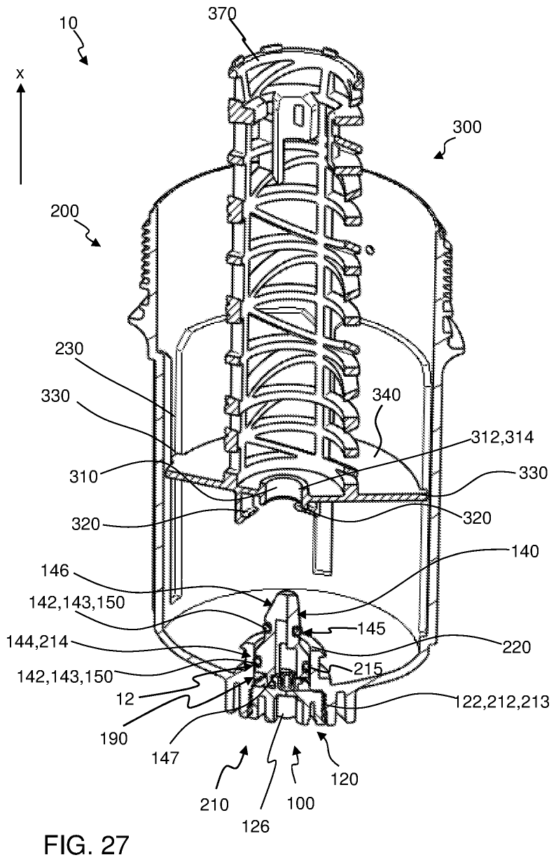

FIG. 27 shows a perspective section illustration of an embodiment of a filter system 10 with a further embodiment of a filter housing 200, a further embodiment of a filter element 300 in an intermediate position, and the sixth embodiment of the closure element 100.

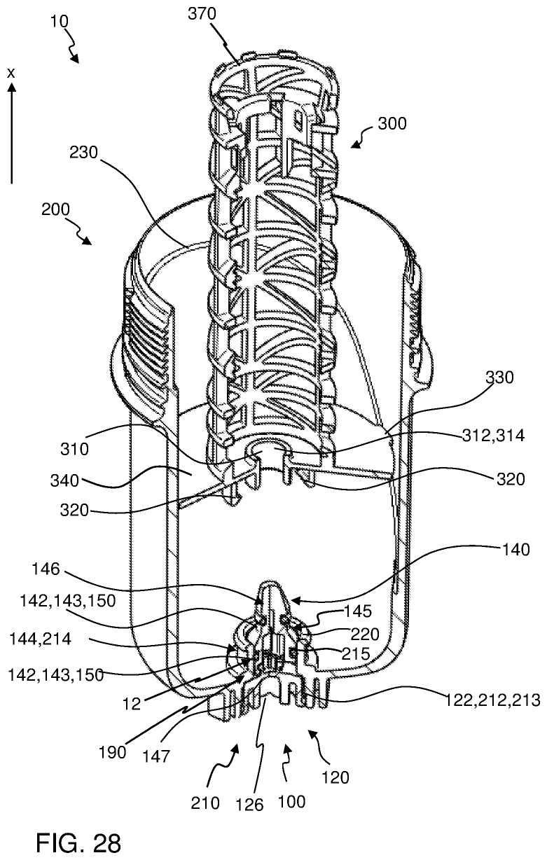

FIG. 28 shows a perspective section illustration of an embodiment of a filter system 10 with a further embodiment of a filter housing part 200, a further embodiment of a filter element 300 in an intermediate position, and the sixth embodiment of the closure element 100.

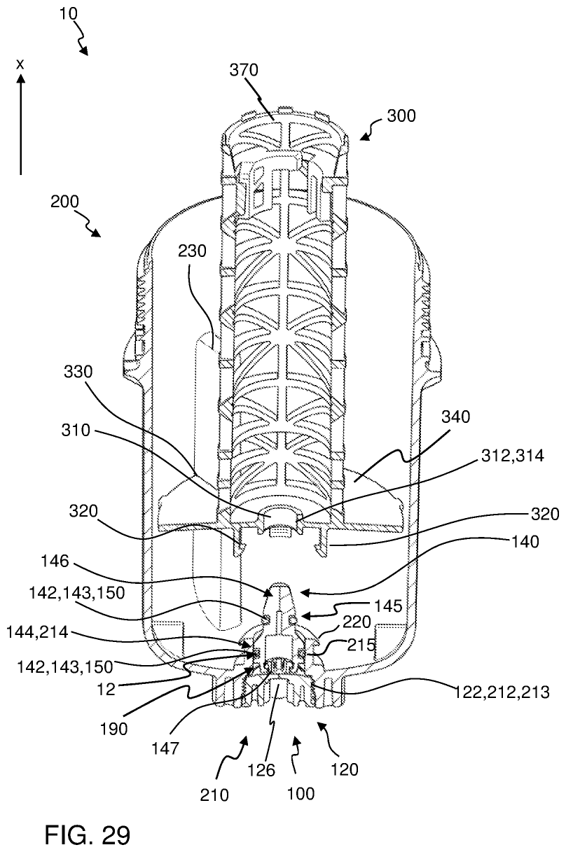

FIG. 29 shows in a perspective section illustration an embodiment of a filter system 10 with a further embodiment of a filter housing part 200, a further embodiment of a filter element 300 in an intermediate position, and the sixth embodiment of the closure element 100.

First, the commonalities of the different embodiments of the closure element 100 will be described. In the further course, the differences in the embodiments will be explained.

As can be seen in FIGS. 1 to 17, 19, 20, and 25 to 28, the closure element 100 for at least one drainage opening 210, 310 of a filter system 10 comprises a connection segment 120 and a closure segment 140 adjoining it in longitudinal direction x and comprising at least one seal region 142. The connection segment 120 and the closure segment 140 each comprise at least one center axis 160, 181, 182 extending in longitudinal direction x, wherein at least one of the center axes 181, 182 of the closure segment 140 is arranged offset in relation to at least one of the center axes 160 of the connection segment 120. The closure element 100 can be of a one-part configuration in an embodiment which is not illustrated. In this context, the connection segment 120 and closure segment 140 can be rigidly or fixedly connected to each other. In the illustrated embodiments, the connection segment 120 and the closure segment 140 are coupled to each other by a suitable coupling arrangement 190.

As can be further seen in FIGS. 1 to 17, 19, 20, and 25 to 28, the connection segment 120 in the illustrated embodiments is supported rotatably at the closure segment 140. In this context, a coupling arrangement 190 comprises coupling elements 147 embodied as locking hooks and coupling elements 124 embodied as edges, wherein the locking hooks interact with the edges, wherein by the engagement of the locking hooks at the edges a rotation about an axis extending in longitudinal direction x is possible. A movement of a segment 120, 140 in axial direction is not possible without the segment coupled thereto (or only to the extent to which the segments have clearance relative to each other). Other suitable coupling arrangements 190 are also conceivable.

As can be further seen in FIGS. 1 to 17, 19, 20, and 25 to 28, in the illustrated embodiments the connection segment 120 is arranged in longitudinal direction x in front of the closure element 140. In addition, the largest diameter of the closure segment 140 is smaller than the smallest diameter of the connection segment 120. Therefore, the connection segment 120 projects past the closure segment 140. The closure segment 140 does not project in any section 144, 145, 146 past the connection segment 120. In an alternative embodiment, not illustrated, a different arrangement of the segments 120, 140 is conceivable also. In addition, the closure element 100 in a further embodiment, not illustrated, can comprise further segments 120, 140. Due to the axis offset v, the closure element 100 can be inserted only into a drainage opening 210, 310 whose cross section in the region in which the closure segment 140 can be arranged is larger by the axis offset v than the cross section of the closure segment 140 or which also comprises the axis offset v.

As can be seen in FIGS. 4, 8, 12, 14, 16, 17, 18, 19, 20, 21, 23, 25, 26, 27, 28, and 29, an outer contour of the connection segment 120 is adapted at least partially to an inner contour of a connection section 212 of the corresponding drainage opening 210 which is seal-tightly closed by the closure element 100 in at least one first position. In the illustrated embodiments of the closure element 100, the connection segments 120 comprise a round cross section. The connection sections 212 of the correspondingly illustrated drainage openings 210 comprise also round cross sections. However, other suitable shapes of the cross sections are conceivable.

As can be further seen in FIGS. 4, 8, 12, 14, 16, 17, 18, 19, 20, 21, 23, 25, 26, 27, 28, and 29, an outer contour of a first section 144 of the closure segment 140 at least partially is adapted to an inner contour of a seal section 214 of the corresponding drainage opening 210. In the illustrated embodiments of the closure segment 100, the closure segments 140 comprise a round cross section. However, other suitable shapes are conceivable also. In addition, the sections 144, 145, 146 of the closure segment 140 can comprise differently shaped cross sections. The seal sections 214, 312 of the correspondingly illustrated drainage openings 210, 310 have also round cross sections. However, other suitable shapes are conceivable also.

As can be further seen in FIGS. 4, 8, 12, 14, 16, 17, 18, 19, 20, 21, 23, 25, 26, 27, 28, and 29, the illustrated embodiments of the closure element 100 each comprise only one connection segment 120 which comprises at least one connection element 122 which is embodied complementarily to a connection element 213 of the drainage opening 210. In the illustrated embodiments, the connection element 122 corresponds to an outer thread which can be screwed into the corresponding connection element 213 of the drainage opening 210 embodied as an inner thread. Due to the rotatable support of the connection segment 120 at the closure segment 140, the rotational movement upon screwing in the connection segment 120 is not or hardly transmitted to the closure segment 140. The movement in longitudinal direction x is transmitted onto the closure segment 140 by the coupling arrangement 190 so that the closure segment 140 can be moved in longitudinal direction x in the direction of the corresponding seal section 214, 312. In an alternative embodiment, not illustrated, another suitable connection, instead of the screw connection, can also connect the connection segment 120 to the connection section 212. Conceivable is a bayonet connection, a clip connection, a snap connection, a locking connection or a clamping connection. In this context, corresponding connection elements 122, 213 can be arranged at the connection segment 120 and at the connection section 212. In addition, different connection types can be combined with each other.

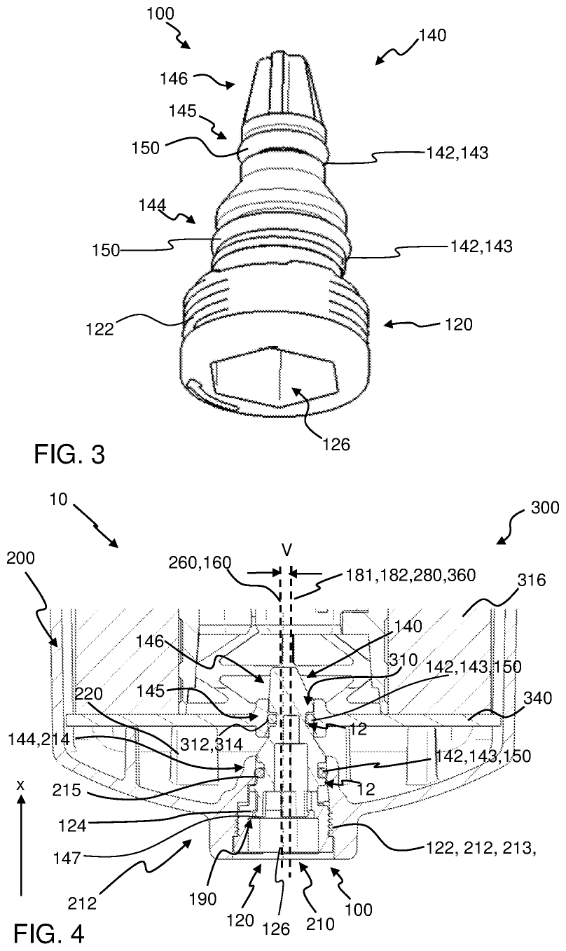

As can be further seen in FIGS. 1 to 17, 19, 20, and 25 to 28, the connection segment 120 comprises at an end region at least one actuation element 126 for introducing an actuation moment. The actuation element 126 is arranged at the end region facing away from the closure segment 140. As can be seen further in FIGS. 3, 7, and 11, the actuation element 126 in the illustrated embodiments is configured as an engagement contour for a hexagon wrench. By means of the hexagon wrench, a torque can be transmitted through the actuation element 126 onto the connection segment 120 and screwing in can be facilitated. However, other configurations of the actuation element 126 are conceivable also.

As can be further seen in FIGS. 1 to 4, the closure element 100 in the illustrated first embodiment comprises a closure segment 140 with three sections 144, 145, 146. Two of the three sections 144, 145 each comprise at least one seal region 142 and a center axis 181, 182. In this context, the first section 144 is configured to form with at least one seal element 150 and a seal section 214 of the drainage opening 210 of the filter housing part 200 a seal arrangement 12. The second section 145 is designed to form with at least one seal element 150 and a seal section 312 of the drainage opening 310 of a filter element 300 a seal arrangement 12. The seal regions 142 are arranged spaced apart from each other in longitudinal direction.

The seal regions 142 of the sections 144, 145 each comprise a seal receptacle 143 which is embodied as a seal groove and surrounds the respective section 144, 145. The seal regions 142 are designed to accommodate a respective seal element 150. In an alternative embodiment, not illustrated, the seal elements 150 can also be received in a seal receptacle in the seal region 215, 314 of the seal section 214, 312 of the drainage opening 210, 310. In a further alternative embodiment, the seal regions 142 can also receive a plurality of seal elements 150. For example, the seal regions 142 can comprise a seal surface at which a plurality of seal elements 150 can rest. In addition, the seal regions 142 can comprise a plurality of seal receptacles 143. In addition, the seal regions 142 of the sections 144, 145 can be designed differently.

In the illustrated embodiment, the first section 144 and the second section 145 are arranged substantially with rotational symmetry in relation to the respective center axis 181, 182. In particular the seal receptacles 143 are arranged with rotational symmetry to the respective center axis 181, 182. The center axes 181, 182 extend in the illustrated example congruently in longitudinal direction x. In this way, the seal receptacles 143 of the sections 144, 145 are arranged coaxially to each other. The center axes 181, 182 are arranged offset in relation to a center axis 160 of the connection segment 120. In this way, the seal receptacles 143 of the sections 144, 145 are arranged eccentrically to the connection segment 120. In this context, the center axes 181, 182 of the closure segment 140 are offset by 0.5 mm in relation to the center axis 160 of the connection segment 120. In addition, the connection segment 120 comprises a larger diameter than the first section 144 of the closure segment 140 and the first section 144 of the closure segment 140 comprises a larger diameter than the second section 145 of the closure segment 140. The third section 146 of the closure segment 140 comprises at least one slant. In this way, the diameter of the third section 146 decreases continuously in longitudinal direction x. In addition, the end face of the third section 146 comprises a center axis which is arranged congruently in relation to the center axis 160 of the connection segment 120. The slant of the third section 146 can facilitate insertion into a drainage opening 210, 310 and can act as a guide for insertion.

As can be seen furthermore in FIG. 4, the second section 145 and the third section 146 of the closure segment 140 project in at least one first position into an interior of the filter housing part 200. A drainage opening 310 of a filter element 300 projecting into the interior projects with an end region also into the interior. In this context, a center axis 360 of the drainage opening 310 is arranged congruently with a center axis 280 of a seal section 214 of the drainage opening 210 of the filter housing part 200 so that the second section 145 and the third section 146 project into the drainage opening 310 of the filter element 300. In this context, the second section 145 forms with at least one seal element 150 and with the seal section 312 of the drainage opening 310 of the filter element 300 a seal arrangement 12. The third section 146 projects into an interior of the filter element 300.

In the illustrated embodiment, the closure segment 140 comprises coupling elements 147 which are embodied as locking hooks wherein the hook tips extend radially from the interior to the exterior, respectively. The locking hooks contact a coupling element 124 of the connection segment 120 which is embodied as a bottom side of a projection. The thus resulting friction-fit coupling arrangement 190 couples the closure segment 140 to the connection segment 120. Other configurations of the coupling arrangement 190 are also conceivable. For example, the connection segment 120 can comprise the locking hooks and the closure segment 140 a suitable engagement surface. In addition, additional cutouts are conceivable in which the locking hooks can engage. Furthermore, other coupling arrangements 190 are conceivable.

As can be further seen in FIGS. 5 to 8, the second embodiment of the closure element 100 differs from the first embodiment of the closure element 100 substantially in that the closure segment 140 comprises only the first section 144 and the second section 145. Due to the missing third section 146, the second embodiment of the closure element 100 is shorter than the first embodiment of the closure element 100 and does not project in the at least one first position into the interior of the filter element 300. In addition, the end face of the second section 145 comprises a center axis which is arranged congruently in relation to the center axes 181, 182 of the closure segment 140.

As can be further seen in FIGS. 9 to 12, the third embodiment of the closure element 100 differs from the first embodiment and from the second embodiment of the closure element 100 substantially in that the closure segment 140 comprises only the first section 144 and therefore only one center axis 181 which is arranged offset in relation to the center axis 160 of the connection segment 120. Due to the missing second section 145 and the missing third section 146, the third embodiment of the closure element 100 is shorter than the first embodiment and the second embodiment of the closure element 100 and projects only barely from the drainage opening 210 of the filter housing part 200 into its interior. In this context, the closure element 100 covers seal-tightly only the drainage opening 210 of the filter housing part 200 in the at least one first position. The filter element, not illustrated, can then be configured without drainage opening or the latter can be closed in a different way.

As can be further seen in FIGS. 13 and 14, the fourth embodiment of the closure element 100, like the third embodiment of the closure element 100, comprises a closure segment 140 with only a first section 144. The difference in relation to the other embodiments lies in the coupling arrangement 190. In the illustrated embodiment, the closure segment 140 comprises coupling elements 147 embodied as locking hooks, wherein the hook tips extend radially from the exterior to the interior, respectively. The locking hooks are positioned at a coupling element 124 of the connection segment 120 which is formed as an underside of a projection.

As can be further seen in FIGS. 15 and 16, the fifth embodiment of the closure element 100 differs from the fourth embodiment of the closure element 100 substantially in that the connection segment 120 comprises an additional section which comprises a larger diameter than the connection element 122. The section is arranged in longitudinal direction x behind the connection element 122 and projects past the connection element 122. This additional rim at the connection segment 120 differentiates the fifth embodiment of the closure element 100 from the other embodiments of the closure element 100.

The sixth embodiment of the closure element 100 illustrated in FIGS. 17 and 18 is substantially embodied like the first embodiment of the closure element 100. The difference between the embodiments lies in the coupling arrangement 190. In the illustrated sixth embodiment, the closure segment 140 comprises coupling elements 147 embodied as locking hooks, wherein the hook tips extend radially from the exterior to the interior, respectively. The locking hooks are positioned at a coupling element 124 of the connection segment 120 which is embodied as an underside of a projection.

The seventh embodiment of the closure element 100 illustrated in FIG. 19 differs from the first embodiment of the closure element 100, from the second embodiment of the closure element 100, and from the sixth embodiment of the closure element 100 in that the closure segment 140 comprises no third section 146 and in that the second section 145 comprises a receptacle for the drainage opening 310 of the filter element 300. The center axis of this receptacle is congruently arranged in relation to the center axis 182 of the second section 145. In the at least one first position, the drainage opening 310 of the filter element 300 is inserted into the receptacle of the second section 145. In this context, the seal element 150 is arranged between a seal region 142 at an inner side of the receptacle and a seal region 314 at an outer side of the drainage opening 310 of the filter element 300. The seal region 314 of the outer side of the drainage opening 310 of the filter element 300 is embodied as a seal receptacle. The seal region 142 at the inner side of the receptacle is embodied as a seal surface. A switched arrangement of seal receptacle and seal surface would also be conceivable. In addition, an arrangement of the center axis of the receptacle offset in relation to the center axis 182 of the second section 145 would also be conceivable in an alternative embodiment. A further alternative configuration would be a second section 145 with receptacle for the drainage opening 310, wherein the center axis 182 of the second section 145 is arranged offset in relation to the center axis 181 of the first section 144. The orientation of the drainage opening 310 at the filter element 300 or the orientation of the filter element 300 in the interior of the filter housing part 200 is adapted accordingly, or the closure element 100 can be adapted in this way to an orientation of the drainage opening 310 of the filter element 300 so that the center axis 360 of the drainage opening 310 is arranged congruently in relation to the center axis of the receptacle.

The eighth embodiment of the closure element 100 illustrated in FIG. 20 differs from the first embodiment of the closure element 100, from the second embodiment of the closure element 100, from the sixth embodiment of the closure element 100, and from the seventh embodiment of the closure element 100 in that the first section 144 of the closure segment 140 comprises a center axis 181 which is offset in relation to the center axis 160 of the connection segment 120 and offset in relation to the center axis 182 of the second section 145. In this way, the first section 144 is arranged eccentrically in relation to the connection segment 120 and eccentrically in relation to the second section 145. In the illustrated embodiment, the center axis 182 of the second section 145 is arranged congruently in relation to the center axis 160 of the connection segment 120. In this way, a center axis 360 of the drainage opening 310 of the filter element 300 is to be aligned congruently in relation to the center axis 160 of the connection segment 120 in order to enable a sealing action of the drainage opening 310 by the second section 145. In an alternative embodiment, the second section 145 can comprise a center axis 182 which is arranged offset in relation to the center axis 181 of the first section 144 and offset in relation to the center axis 160 of the connection segment 120. In this context, the center axis 360 of the drainage opening 310 of the filter element is to be aligned correspondingly. A further embodiment can correspond to the eighth embodiment, wherein the closure segment 140 can comprise additionally the third section 146 or a second section 145 with receptacle for the drainage opening 310 of the filter element 300.

In the following, embodiments of a filter housing part 200 will be described, wherein first the commonalities and in the further course the differences will be explained.

As can be seen in FIGS. 4, 8, 12, 14, 16, 17, 18, 19, 20, 21, 23, 25, 26, 27, 28, and 29, the filter housing part 200 for the filter system 10 comprises the interior and the drainage opening 210 coupled to the interior. The drainage opening 210 is arranged in longitudinal direction x at the bottom at the filter housing part 200 so that a fluid, upon release of the drainage opening 210, can flow out of the interior driven by the force of gravity. The drainage opening 210 comprises at least two sections 212, 214 arranged successively in longitudinal direction x. At least one connection section 212 comprises a center axis 260 extending in longitudinal direction x. At least one seal section 214 comprises a center axis 280 extending in longitudinal direction x and at least one seal region 215. The center axis 260 of the at least one connection section 212 is offset in relation to the center axis 280 of the at least one seal section 214. Here, the axis offset v of the center axes 260, 280 of the drainage opening 210 corresponds to the axis offset v of the corresponding closure element 100 which can be inserted into the drainage opening 210 and closes seal-tightly the drainage opening 210 in at least one first position. The closure element 100 is embodied in accordance with one of the already described embodiments.

The illustrated embodiments of the filter housing part 200 comprise only one connection section 212, respectively, and only one seal section 214 in the drainage opening 210, respectively. In an alternative embodiment, not illustrated, the drainage opening 210 can also comprise a plurality of connection sections 212 or a plurality of seal sections 214 or a plurality of seal sections 214 and a plurality of connection section 212. The respective seal section 214 of the drainage opening 210 comprises a seal region 215 which is formed as a seal surface. A seal element 150 can contact this seal surface. In an alternative embodiment, the seal region can also be configured as a receiving groove for a seal element 150.

As can be further seen in FIGS. 4, 8, 12, 14, 16, 17, 18, 19, 20, 21, 23, 25, 26, 27, 28, and 29, the illustrated embodiments of the filter housing part 200 comprise a round cross section. The drainage opening 210 comprises a plurality of round cross sections with various diameters. Correspondingly, the corresponding closure elements 100 also comprise round cross sections. The drainage opening 210 and the corresponding closure element 100 are adapted to each other such that an inner diameter of the drainage opening 210 and an outer diameter of the closure element 100 are selected such that, in at least one first position of the closure element 100, the connection section 212 of the drainage opening 210 and the connection segment 120 of the closure element 100 form a detachable connection and the seal region 142 of the closure segment 140 of the closure element 100 form with the at least one seal region 215 of the seal section 214 of the drainage opening 210 a seal arrangement 12 with the seal element 150 which is arranged between the seal regions 142, 215.

In the at least one first position of the closure element 100, at least one center axis 160 of the connection segment 120 of the closure element 100 is arranged congruently in relation to the center axis 260 of the at least one connection region 212 of the drainage opening 210. The center axis 181 of the first section 144 of the closure segment 140 is arranged congruently in relation to the center axis 280 of the at least one seal region 214. The center axes 260, 280 of the drainage opening must not be arranged congruently in relation to a center axis of the filter housing part 200.

In the illustrated embodiments, the seal arrangement 12 comprises between the first section 144 and the seal section 214 of the drainage opening 210 an annular seal element 150 which is arranged between a seal region 142 of the first section 144 and a seal region 215 of the seal section 214. The annular seal element 150 is arranged in a seal receptacle 143, configured as a seal groove, of the seal region 142 of the first section of the closure segment 140 and surrounds the closure segment 140 in the seal region 142. In the at least one first position, the seal element 150 contacts the seal region 215, embodied as a seal surface, of the seal section 214 of the drainage opening 210. In an alternative embodiment, other shapes of the seal element 150 and of the seal regions 142, 215 are conceivable also. For example, the seal section 214 can comprise a seal receptacle and the seal region 142 of the first section 144 can comprise the seal surface. In addition, the seal arrangement 12 can comprise more than one seal element 150.

When one of the embodiments of the closure element 100 is arranged with a second section 145, or a second section 145 and a third section 146, in the drainage opening 210, then the second section 145 projects, or the second section and the third section 146 project, in the at least one first position at least partially into the interior of the filter housing part 200. In this context, the sections 145, 146 can project into a drainage opening 310 of the filter element 300 which projects into the interior.

In the illustrated embodiments of the filter housing part, the at least one connection section 212 is arranged at a region of the drainage opening 210 facing away from the interior of the filter housing part 200 and the at least one seal section 214 is arranged at a region of the drainage opening 210 which is facing the interior of the filter housing part 200. In this way, the seal arrangement 12 is arranged in the inwardly positioned, protected region of the drainage opening 210 so that the seal element 150 is protected from outer influences. In the illustrated embodiments, the connection section 212 of the drainage opening 210 comprises a larger cross section than the at least one seal section 214 of the drainage opening 210. The region of the connection segment 120 overlapping the closure segment 140 covers additionally the seal section 214 of the drainage opening 210. In addition, in the transition region between the connection section 212 and the seal section 214, shoulders are arranged at the inner contour of the drainage opening 210 which act as a stop for the segments 120, 140 or sections 144, 145 of the segments 120, 140.

In the illustrated embodiments of the filter housing part 200, the connection section 212 of the drainage opening 210 and the connection segment 120 of the closure element 100 each comprise connection elements 122, 213 which are detachable and complementary to each other. In this context, the connection element 122 corresponds to an outer thread which can be screwed into the corresponding connection element 213 of the drainage opening 210 which is correspondingly embodied as an inner thread. Due to the rotatable support of the connection segment 120 at the closure segment 140, the rotational movement upon screwing in the connection segment 120 is not or hardly transmitted to the closure segment 140 so that no or only few radial forces or shearing forces are acting on the seal element 150. By means of the coupling arrangement 190, the movement in longitudinal direction x is transmitted to the closure segment 140 so that the closure segment 140 in longitudinal direction x can be moved in direction of the corresponding seal section 214, 312. By a suitable tool, a torque can be transmitted via the actuation element 126 to the connection segment 120 and screwing in can be facilitated. In an alternative embodiment, not illustrated, instead of the screw connection also another suitable connection can connect the connection segment 120 to the connection section 212. Conceivable is a bayonet connection, a clip connection, a snap connection, a locking connection or a clamping connection. In this context, corresponding connection elements 122, 213 can be arranged at the connection segment 120 and at the connection section 212. In addition, different connection types can be combined with each other.

In an alternative embodiment, not illustrated, the filter housing part 200 comprises a profile at walls of the drainage opening 210 which are arranged outside of the at least one seal region 215. This profile characterizes regions at which the seal element 150 is not to be arranged. In this way, the intended region for the seal element 150 can be more easily detected. In addition, it can be ensured that the seal element 150 is arranged in the less exposed region within the drainage opening 210.

The filter housing parts 200 illustrated in FIGS. 4, 8, 12, 14, 16, 17, 19, 20 differ substantially in that the dimensions of the drainage opening 210, in particular the sections 212, 214 of the drainage opening 210, are adapted to different closure elements 100 and their axis offset.

In FIG. 21, an exterior view of an embodiment of the filter housing part 200 is illustrated which shows guide elements 230 from the exterior. In addition, the drainage opening 210 is released.

FIG. 22 shows a section illustration along the section plane XII of FIG. 21. In this context, a filter element 300 is arranged the filter housing part 200 and a closure element 100 according to the first embodiment in the drainage openings 210, 310. The filter element 300 comprises guide elements 330 which are guided by the guide elements 230 of the filter housing part 200. As can be seen in FIG. 22, one guide element 330 of the filter element 300 is embodied wider than the two other guide elements 330. The filter housing part 200 comprises a correspondingly wider guide element 230 and two narrower guide elements so that the orientation of the filter element 300 in the filter housing part 200 and the orientation of the drainage opening 310 of the filter element 300 in relation to the drainage opening 210 of the filter housing part 200 are predetermined. Other guide elements 230, 330 and other arrangements are also conceivable. By means of the guide elements 230, 330, it can be ensured that the center axis 360 of the drainage opening 310 is arranged in relation to the drainage opening 210 of the filter housing 200 such that a center axis 182 of the second section of the closure element 100 is arranged congruently in relation to the center axis 360 of the drainage opening. In the illustrated embodiment, the center axis 360 of the drainage opening 310 is additionally arranged congruently in relation to the center axis 181 of the first section of the closure element 100 and congruently in relation to the center axis 280 of the seal section 214 of the drainage opening 210 of the filter housing part 200. Depending on the embodiment of the closure element 100, the orientation of the center axis 360 of the drainage opening 310 of the filter element 300 in relation to the center axes 280, 260 of the drainage opening 210 of the filter housing part 200 can vary. The drainage opening 310 of the filter element 300 is arranged eccentrically in relation to the end disk 340 at which it is arranged and eccentrically in relation to a center tube 370 which supports a filter medium 316 from the interior. A different configuration of the center tube 370 is also conceivable. The center tube 370 and the end disk 340 comprise center axes which are arranged congruently in relation to the center axis 160 of the connection segment 120 and in relation to the center axis 260 of the connection section 212. This can however vary without having an influence on the sealing action of the drainage opening 310. In order to achieve sealing of the drainage opening 310, the drainage opening 310 must be positioned above the drainage opening 210 of the filter housing part 200 such that the center axis 360 of the drainage opening 310 is arranged congruently in relation to the center axis 182 of the second section 145 of the closure element 100 which can be arranged in the drainage opening 210 of the filter housing part 200.

The embodiments of the filter housing part 200 illustrated in FIGS. 21 to 28 differ from each other essentially in the configuration of the guide elements 230.

In FIG. 22, the guide element 230 is configured as a recess in which a corresponding guide element 330 of the filter element 300 embodied as a bulge is guided. The filter housing part 200 comprises a plurality of such guide elements 230.

In FIGS. 23, 25, and 26, the guide element 230 is configured as a bulge or as a rail which is arranged in a guide element of the filter element 300 embodied as a receptacle. In addition, FIGS. 25 and 26 show different positions of the filter element 300 upon insertion or removal of the filter element 300 into or out of the filter housing part 200. The filter housing part 200 comprises a plurality of such guide elements 230.

In FIG. 27, the guide element 230 is configured as a recess in which a corresponding guide element 330 of the filter element 300 embodied as a bulge is guided. In contrast to the embodiment illustrated in FIG. 22, the recess is not punched into the housing wall but is realized by an additional component inserted into the interior. The filter housing part 200 comprises a plurality of such guide elements 230.

In FIG. 28, the guide element 230 is embodied as a downwardly bent guide edge at which a guide element 330 of the filter element 300 which is embodied as a bulge is guided.

In FIG. 29, the filter housing part 200 comprises a large, inwardly projecting guide element 230 which is guided in a guide element 330 of the filter element 300 which is embodied as a bulge.

In the following, embodiments of a described filter system 10 are described, wherein first the communalities and during the further course the differences will be explained.

As can be seen in FIGS. 4, 8, 17, 19, 20, 22, 25, 26, 27, 28, and 29, the embodiments of the filter system 10 comprise a filter housing part 200 which comprises an interior and a drainage opening 210 which is coupled to the interior. A closure element 100 closes the drainage opening 210 in at least one first position seal-tightly and at least partially releases the drainage opening 210 in at least one second position, not illustrated. In the second position of the closure element 100, the closure element can release a passage in the drainage opening 210; alternatively, the closure element 100 can be arranged outside of the drainage opening 210 so that the drainage opening 210 is completely released.

In the interior of the filter housing part 200, a filter element 300 with a drainage opening 310 is arranged. An end region of the drainage opening 310 of the filter element 300 facing the filter housing part 200 is fluidically coupled to the drainage opening 210 of the filter housing part 200. A filter housing part, not illustrated, can form a closed filter housing with the illustrated filter housing part 200. The filter housing part, not illustrated, can comprise an inlet opening and can be detachably connected to the illustrated filter housing part 200. Due to the two-part filter housing, the filter element 300 arranged in the interior can be easily exchanged, as needed. The filter system 10 is embodied as a liquid filter, in particular as a fuel filter or as an oil filter. In this context, the liquid to be filtered flows through the inlet opening into the filter housing, flows through the filter element 300, and the filtered fluid flows through the drainage opening 210 of the filter housing part 200 out of the filter housing. As needed, the closure element 100 can be introduced at least into the drainage opening 210 of the filter housing part 200 in one of the first positions so that an escape of the fluid from the filter housing part 200 can be prevented.

As can be further seen in FIGS. 4, 8, 17, 19, 20, 22, 25, 26, 27, 28, and 29, the filter element 300 comprises a center tube 370 which supports a filter medium 316 from the interior and at least one end disk 340, wherein the at least one end disk 340 comprises a drainage opening 310 with at least one center axis 360 and at least one seal region 314. The center axis 360 of the drainage opening 310 is arranged in the illustrated embodiments offset in relation to the center axis of the end disk 340 and in relation to the center axis of the center tube 370. A congruent arrangement of the center axes 360 is conceivable also. When the closure element 100 in the embodiment comprises only the first section 144, the filter element can be configured without drainage opening or the latter can be closed in a different way. When the closure element 100 in the embodiment comprises the first section 144 and the second section 145, at least one section 144, 145 of the closure segment 140 of the closure element 100, which projects into the interior of the filter housing part 200, projects into the drainage opening 310 of the filter element 300 in the at least one first position of the closure element 100. In this way, the formed seal arrangement 12 seals the drainage opening 310 of the filter element 300 in the corresponding seal region 142. In addition, a drainage opening 210 of the filter housing 200 is seal-tightly closed. A further position is conceivable in which the drainage opening 310 of the filter element 300 is at least partially released and the drainage opening 210 of the filter housing part 200 is closed. For sealing the drainage opening 310 of the filter element 300, the center axis 360 of the drainage opening 310 is arranged in such a way in relation to the drainage opening 210 of the filter housing part 200 that a center axis 182 of the second section of the closure element 100 is arranged congruently in relation to the center axis 360 of the drainage opening 310.

As can be further seen in FIGS. 4, 8, 17, 19, 20, 22, 25, 26, 27, 28, and 29, a cross section of the drainage opening 310 of the filter element 300 is smaller than at least one of the cross sections of the drainage opening 210 of the filter housing part 200. In this context, the drainage opening 310 can act as a funnel and guide the fluid into the drainage opening 210 of the filter housing part 200. In addition, an end region of the drainage opening 310, as illustrated in FIG. 19, can be arranged in a receptacle of the second section 145.

As can be further seen in FIGS. 4, 8, 17, 19, 20, 22, 25, 26, 27, 28, and 29, the filter element 300 is detachably fastened by a fastening arrangement at the filter housing part 200, wherein the fastening arrangement comprises filter element-associated fastening elements 320 and housing part-associated fastening elements 220 interacting therewith. The distribution of the fastening elements 320 at the filter element 300 is limited only by the position of the fastening elements 220 at the filter housing part 200 or by the formation of pairs of filter element-associated fastening elements 320 and housing part-associated fastening elements 220. In this context, the fastening elements 320, 220, as illustrated in the FIGS. 17, 19, 20, 23, 24, 25, and 26, are embodied as snap hooks which interact in pairs. As an alternative, a fastening element 220 can be designed as an engagement edge which interacts with one or a plurality of snap hooks, as in the FIGS. 27, 28.

As can be further seen in FIGS. 4, 8, 17, 19, 20, 22, 25, 26, 27, 28, and 29, a housing wall of the filter housing part 200 comprises guide elements 230 guiding guide elements 330 of the filter element 300. By guiding the filter element 300 into an end position, fastening elements 320 arranged at the filter element 300 and fastening elements 220 arranged at the filter housing part 200 can be joined with each other and the drainage opening 310 of the filter element 300 can be fluidically coupled to the drainage opening 210 of the filter housing part 200. In addition, the orientation of the drainage opening 310 in relation to the second section 145 of the closure element 100 can be realized by the guiding action.

In a use of a filter element 300 in a filter system 10, not illustrated in detail, the filter element 300 is inserted into an interior of the filter housing part 200 and oriented in relation to the filter housing part 200 such that at least one center axis 360 of the drainage opening 310 of the filter element 300 is arranged offset in relation to at least one center axis 260, 280 of the drainage opening 210 of the filter housing part 200. In addition, the filter element 300 can be oriented in relation to the filter housing part 200 such that filter element-associated fastening elements 320 and housing part-associated fastening elements 220 form a detachable fastening of the filter element 300 at the filter housing part 200.

In a use of a closure element 100 in a filter system 10, not explained in more detail, the closure element 100 is inserted into the drainage opening 210 of the filter housing part 200. At least one first section 144 of the closure segment 140 projects into the at least one seal section 214 of the drainage opening 210, wherein the at least one seal region 142 of the closure segment 140, at least one seal region 215 of the seal section 214 of the drainage opening 210, and at least one seal element 150 seal the drainage opening 210 in the corresponding seal section 214, wherein the center axis 181 of the first section 144 is arranged congruently in relation to the center axis 280 of the seal section 214. A connection element 122 of the connection segment 120 of the closure element 100 forms with a connection element 213 of the connection section 212 of the drainage opening 210 a detachable connection, wherein the center axis 160 of the connection segment 120 is arranged congruently in relation to the center axis 280 of the connection section 212. In addition, at least one second section 145 of the closure segment 140 can project into the drainage opening 310 of the filter element 300, wherein the corresponding seal region 314, the at least one seal region 142 of the second section 145, and at least one seal element 150 seal the drainage opening 310, wherein the center axis 182 of the second section 145 is arranged congruently in relation to the center axis 360 of the drainage opening 310.

1. A closure element for at least one drainage opening of a filter system, the closure element comprising:
a connection segment; and
a closure segment adjoining the connection segment in a longitudinal direction and comprising one or more seal regions,
wherein the connection segment and the closure segment each comprise one or more center axes extending in the longitudinal direction, and
wherein at least one of the center axes of the closure segment is arranged offset in relation to at least one of the center axes of the connection segment.

2. The closure element according to claim 1, wherein the connection segment is supported rotatably at the closure segment.

3. The closure element according to claim 1, wherein the closure segment comprises two or more sections,
wherein the sections each comprise one of the seal regions and a center axis,
wherein the seal regions are spaced apart from each other axially, and
wherein the center axes are positioned coaxially or offset in relation to each other.

4. The closure element according to claim 3, wherein at least one of the seal regions comprises at least one seal element or provides a seal surface.

5. The closure element according to claim 4, wherein the two or more sections comprise a section arranged near the connection segment and further comprise a section arranged remote from the connection segment,
wherein the seal region of the section arranged near the connection segment comprises the at least one seal element, and
wherein the seal region of the section arranged remote from the connection segment comprises the at least one seal element or provides the seal surface.

6. The closure element according to claim 5, wherein one of the center axes of the closure element is provided at the section arranged remote from the connection segment and is coaxial to the center axis of the connection segment.

7. The closure element according to claim 4, wherein the at least one seal element is a radial seal element, and
wherein the seal surface is a radial inner or outer seal surface.

8. The closure element according to claim 1, wherein the connection segment comprises at least one connection element configured complementary to a connection element of the at least one drainage opening of the filter system.

9. The closure element according to claim 1, wherein the connection segment comprises an end region comprising at least one actuation element configured for introducing an actuation moment.

10. The closure element according to claim 1, wherein the connection segment comprises a cross section larger than a cross section of the closure segment.

11. A filter housing part for a filter system, the filter housing part comprising:
an interior; and
a drainage opening coupled to the interior, the drainage opening being configured to be seal-tightly closed by the closure element according to claim 1 in at least one first position of the closure element in relation to the drainage opening, and the drainage opening being further configured to be at least partially released in at least one second position of the closure element in relation to the drainage opening,
wherein the drainage opening comprises two or more sections arranged successively in a longitudinal direction of the filter housing part, the sections comprising at least one connection section comprising a center axis extending in the longitudinal direction of the filter housing part, and the sections further comprising at least one seal section comprising a center axis extending in the longitudinal direction of the filter housing part and further comprising at least one seal region,
wherein the center axis of the at least one connection section of the drainage opening is arranged offset in relation to the center axis of the at least one seal section of the drainage opening,
wherein, in at least one of the first positions, the at least one connection section of the drainage opening and the connection segment of the closure element form a detachable connection, and
wherein the one or more seal regions of the closure segment of the closure element and the at least one seal region of the at least one seal section of the drainage opening form a seal arrangement.

12. The filter housing part according to claim 11, wherein the at least one connection section of the drainage opening is arranged at a first region of the drainage opening facing away from the interior of the filter housing part, and
wherein the at least one seal section of the drainage opening is arranged at a second region of the drainage opening facing the interior of the filter housing part.

13. The filter housing part according to claim 11, wherein the at least one connection section of the drainage opening comprises a diameter larger than a diameter of the at least one seal section of the drainage opening.

14. The filter housing part according to claim 11, wherein the at least one connection section of the drainage opening and the connection segment of the closure element each comprise detachable connection elements that are complementary to each other.

15. The filter housing part according to claim 11, wherein the drainage opening comprises walls comprising a profile arranged outside of the at least one seal region.

16. A filter element comprising:
a filter medium; and
at least one end disk comprising an engagement section with a center axis and with at least one at least partially circumferentially extending engagement region,
wherein the center axis of the engagement section is arranged offset in relation to at least one center axis of the filter element and/or offset in relation to a center axis of the at least one end disk.

17. The filter element according to claim 16, wherein the engagement section is a drainage opening passing through the at least one end disk,
wherein the drainage opening is in fluid communication with an interior of the filter element, and
wherein the at least one at least partially circumferentially extending engagement region is a seal region.

18. A filter system comprising:
a filter housing part comprising an interior and a drainage opening coupled to the interior,
wherein the drainage opening comprises two or more sections arranged successively in a longitudinal direction of the filter housing part, the sections comprising at least one connection section comprising a center axis extending in the longitudinal direction of the filter housing part, the sections further comprising at least one seal section comprising a center axis extending in the longitudinal direction of the filter housing part and further comprising at least one seal region, and the center axis of the at least one connection section of the drainage opening being arranged offset in relation to the center axis of the at least one seal section of the drainage opening;
the closure element according to claim 1, the closure element closing seal-tightly the drainage opening in at least one first position and at least partially releases the drainage opening in at least one second position,
wherein, in at least one of the first positions, the at least one connection section of the drainage opening and the connection segment of the closure element form a detachable connection, and
wherein the one or more seal regions of the closure segment of the closure element and the at least one seal region of the at least one seal section of the drainage opening form a seal arrangement; and
a filter element arranged in the interior of the filter housing part, the filter element comprising an engagement section being in engagement or configured to be brought into engagement with the one or more seal regions of the closure segment of the closure element.

19. The filter system according to claim 18, wherein the filter element comprises a filter medium and at least one end disk,
wherein the engagement section of the filter element is arranged at the at least one end disk and comprises a center axis and at least one at least partially circumferentially extending engagement region, the center axis of the engagement section of the filter element being arranged offset in relation to at least one of a first center axis of the filter element and a center axis of the at least one end disk, and
wherein the engagement section of the filter element is a drainage opening fluidically coupled to the drainage opening of the filter housing part.

20. The filter system according to claim 18, wherein the filter element is fastened detachably by a fastening arrangement at the filter housing part, the fastening arrangement comprising filter element-associated fastening elements and housing part-associated fastening elements interacting with the filter element-associated fastening elements.
